(19) United States
(12) Patent Application Publication
(10) Pub. No.: US 2021/0258105 A1
(43) Pub. Date: Aug. 19, 2021

(54) DISCONTINUOUS RECEPTION IN A NETWORK

(71) Applicant: QUALCOMM Incorporated, San Diego, CA (US)

(72) Inventors: Bharat SHRESTHA, San Diego, CA (US); Umesh PHUYAL, San Diego, CA (US); Xiao Feng WANG, San Diego, CA (US); Alberto RICO ALVARINO, San Diego, CA (US); Liangping MA, San Diego, CA (US)

(21) Appl. No.: 17/248,853

(22) Filed: Feb. 10, 2021

Related U.S. Application Data
(60) Provisional application No. 62/976,187, filed on Feb. 13, 2020.

(51) Int. Cl. H04L 1/18; H04W 24/08; H04W 76/28

(52) U.S. Cl. CPC H04L 1/1819; H04W 76/28; H04W 24/08; H04L 1/1896

(57) ABSTRACT

Various aspects of the present disclosure generally relate to wireless communication. In some aspects, a user equipment (UE) may determine an offset associated with a propagation delay in a network, wherein hybrid automatic repeat request (HARQ) feedback is enabled at the UE, and may monitor for a retransmission of a downlink communication in the network according to the offset. In some aspects, a UE may start a timer associated with monitoring for a retransmission of a downlink communication in a network, wherein HARQ feedback is disabled at the UE, and may monitoring for the retransmission of the downlink communication after starting the timer or after expiration of the timer. Numerous other aspects are provided.

### CROSS-REFERENCE TO RELATED APPLICATION

This patent application claims priority to U.S. Provisional Patent Application No. 62/976,187, filed on Feb. 13, 2020, entitled “DISCONTINUOUS RECEPTION IN A NETWORK,” and assigned to the assignee hereof. The disclosure of the prior application is considered part of and is incorporated by reference into this patent application.

### INTRODUCTION

Aspects of the present disclosure generally relate to wireless communication and to techniques and apparatuses for discontinuous reception (DRX).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include determining an offset associated with a propagation delay in a network, wherein hybrid automatic repeat request (HARQ) feedback is enabled at the UE; and monitoring for a retransmission of a downlink communication in the network according to the offset.

In some aspects, a method of wireless communication, performed by a UE, may include starting a timer associated with monitoring for a retransmission of a downlink communication in a network, wherein HARQ feedback is disabled at the UE; and monitoring for the retransmission of the downlink communication after starting the timer or after expiration of the timer.

In some aspects, a method of wireless communication, performed by a base station, may include determining an offset associated with a propagation delay in a network, wherein HARQ feedback is enabled at a UE; scheduling a retransmission of a downlink communication to the UE based at least in part on the offset; and transmitting the retransmission of the downlink communication based at least in part on scheduling the retransmission of the downlink communication.

In some aspects, a method of wireless communication, performed by a base station, may include starting a timer associated with transmitting a retransmission of a downlink communication to a UE in a network, wherein HARQ feedback is disabled at the UE; and transmitting the retransmission of the downlink communication after starting the timer or after expiration of the timer.

In some aspects, a UE for wireless communication may include a memory and one or more processors coupled to the memory. The memory and the one or more processors may be configured to determine an offset associated with a propagation delay in a network, wherein HARQ feedback is enabled at the UE; and monitor for a retransmission of a downlink communication in the network according to the offset.

In some aspects, a UE for wireless communication may include a memory and one or more processors coupled to the memory. The memory and the one or more processors may be configured to start a timer associated with monitoring for a retransmission of a downlink communication in a network, wherein HARQ feedback is disabled at the UE; and monitor for the retransmission of the downlink communication after starting the timer or after expiration of the timer.

In some aspects, a base station for wireless communication may include a memory and one or more processors coupled to the memory. The memory and the one or more processors may be configured to determine an offset associated with a propagation delay in a network, wherein HARQ feedback is enabled at a UE; schedule a retransmission of a downlink communication to the UE based at least in part on the offset; and transmit the retransmission of the downlink communication based at least in part on scheduling the retransmission of the downlink communication.

In some aspects, a base station for wireless communication may include a memory and one or more processors coupled to the memory. The memory and the one or more processors may be configured to start a timer associated with transmitting a retransmission of a downlink communication to a UE in a network, wherein HARQ feedback is disabled at the UE; and transmit the retransmission of the downlink communication after starting the timer or after expiration of the timer.

In some aspects, a non-transitory computer-readable medium may store one or more instructions for wireless communication. The one or more instructions, when executed by one or more processors of a UE, may cause the one or more processors to determine an offset associated with a propagation delay in a network, wherein HARQ feedback is enabled at the UE; and monitor for a retransmission of a downlink communication in the network according to the offset.

In some aspects, a non-transitory computer-readable medium may store one or more instructions for wireless communication. The one or more instructions, when executed by one or more processors of a UE, may cause the one or more processors to start a timer associated with monitoring for a retransmission of a downlink communication in a network, wherein HARQ feedback is disabled at the UE; and monitor for the retransmission of the downlink communication after starting the timer or after expiration of the timer.

In some aspects, a non-transitory computer-readable medium may store one or more instructions for wireless communication. The one or more instructions, when executed by one or more processors of a base station, may cause the one or more processors to determine an offset associated with a propagation delay in a network, wherein HARQ feedback is enabled at a UE; schedule a retransmission of a downlink communication to the UE based at least in part on the offset; and transmit the retransmission of the downlink communication based at least in part on scheduling the retransmission of the downlink communication.

In some aspects, a non-transitory computer-readable medium may store one or more instructions for wireless communication. The one or more instructions, when executed by one or more processors of a base station, may cause the one or more processors to start a timer associated with transmitting a retransmission of a downlink communication to a UE in a network, wherein HARQ feedback is disabled at the UE; and transmit the retransmission of the downlink communication after starting the timer or after expiration of the timer.

In some aspects, an apparatus for wireless communication may include means for determining an offset associated with a propagation delay in a network, wherein HARQ feedback is enabled at the UE; and means for monitoring for a retransmission of a downlink communication in the network according to the offset.

In some aspects, an apparatus for wireless communication may include means for starting a timer associated with monitoring for a retransmission of a downlink communication in a network, wherein HARQ feedback is disabled at the UE; and means for monitoring for the retransmission of the downlink communication after starting the timer or after expiration of the timer.

In some aspects, an apparatus for wireless communication may include means for determining an offset associated with a propagation delay in a network, wherein HARQ feedback is enabled at a UE; means for scheduling a retransmission of a downlink communication to the UE based at least in part on the offset; and means for transmitting the retransmission of the downlink communication based at least in part on scheduling the retransmission of the downlink communication.

In some aspects, an apparatus for wireless communication may include means for starting a timer associated with transmitting a retransmission of a downlink communication to a UE in a network, wherein HARQ feedback is disabled at the UE; and means for transmitting the retransmission of the downlink communication after starting the timer or after expiration of the timer.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with various aspects of the present disclosure.

FIG. 2 is a block diagram illustrating an example of a base station in communication with a user equipment (UE) in a wireless communication network, in accordance with various aspects of the present disclosure.

FIG. 3 is a diagram illustrating an example of conventional discontinuous reception (DRX) operation for a hybrid automatic repeat request (HARQ) process in a non-terrestrial network (NTN) scenario.

FIGS. 4A-4E are diagrams illustrating examples associated with DRX operation in an NTN when HARQ feedback is enabled, in accordance with various aspects of the present disclosure.

FIGS. 5A-5E are diagrams illustrating examples associated with DRX operation in an NTN when HARQ feedback is disabled, in accordance with various aspects of the present disclosure.

FIGS. 6 and 7 are diagrams illustrating example processes performed, for example, by a user equipment, in accordance with various aspects of the present disclosure.

FIGS. 8 and 9 are diagrams illustrating example processes performed, for example, by a base station, in accordance with various aspects of the present disclosure.

FIGS. 10-17 are block diagrams of example apparatuses for wireless communication, in accordance with various aspects of the present disclosure.

### DETAILED DESCRIPTION

As described below, a non-terrestrial network (NTN) may utilize non-terrestrial base stations for providing or assisting UEs with access to a core network. A non-terrestrial base station may be located on a platform, which may be, for example, a satellite (e.g., a low earth orbit (LEO) satellite, a medium earth orbit (MEO) satellite, a geostationary orbit (GEO) satellite, or the like), a balloon, a dirigible, an airplane, an unmanned aerial vehicle (UAV), a drone, or the like. In an NTN system, propagation delay may be significant due to a relatively large distance between a UE and a non-terrestrial base station and/or a relatively large distance between a terrestrial base station and the non-terrestrial base station.

In some cases, disabling hybrid automatic repeat request (HARQ) feedback may be used to avoid stalling of a HARQ process that can result from propagation delay in an NTN system. In a case in which HARQ feedback is disabled, operation of one or more discontinuous reception (DRX) timers may account for (e.g., make up for, be adjusted for, be configured for, or the like) the disabling of HARQ feedback. Furthermore, when HARQ feedback is not disabled, operation of the one or more DRX timers and scheduling of retransmissions may account for the propagation delay present in the NTN system (e.g., so as to prevent stalling of the HARQ process). Some aspects described herein provide techniques and apparatuses for DRX operation in an NTN system. For example, the techniques and apparatuses described herein provide operation of one or more DRX timers and scheduling of a retransmission in a manner that accounts for propagation delay (when HARQ feedback is enabled). As an example, in an aspect in which HARQ feedback is enabled at a UE, the UE may determine an offset associated with a propagation delay in a network (e.g., an NTN network). The UE may then monitor for a retransmission of a downlink communication in the network according to the offset. In this example, the base station may determine the offset associated with the propagation delay in the network (e.g., in a manner similar to that of the UE, may schedule a retransmission of the downlink communication to the UE based at least in part on the offset, and may transmit the retransmission of the downlink communication based at least in part on scheduling the retransmission of the downlink communication, accordingly. Furthermore, the techniques and apparatuses described herein describe operation of one or more DRX timers in a manner that accounts for disabling of HARQ feedback. As an example, in an aspect in which HARQ feedback is disabled at a UE, the UE may start a timer associated with monitoring for a retransmission of a downlink communication in a network, and may monitoring for the retransmission of the downlink communication after starting the timer or after expiration of the timer. In this example, the base station may start a timer associated with transmitting the retransmission of the downlink communication to the UE (e.g., in a similar manner to the UE), and may transmit the retransmission of the downlink communication after starting the timer or after expiration of the timer.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

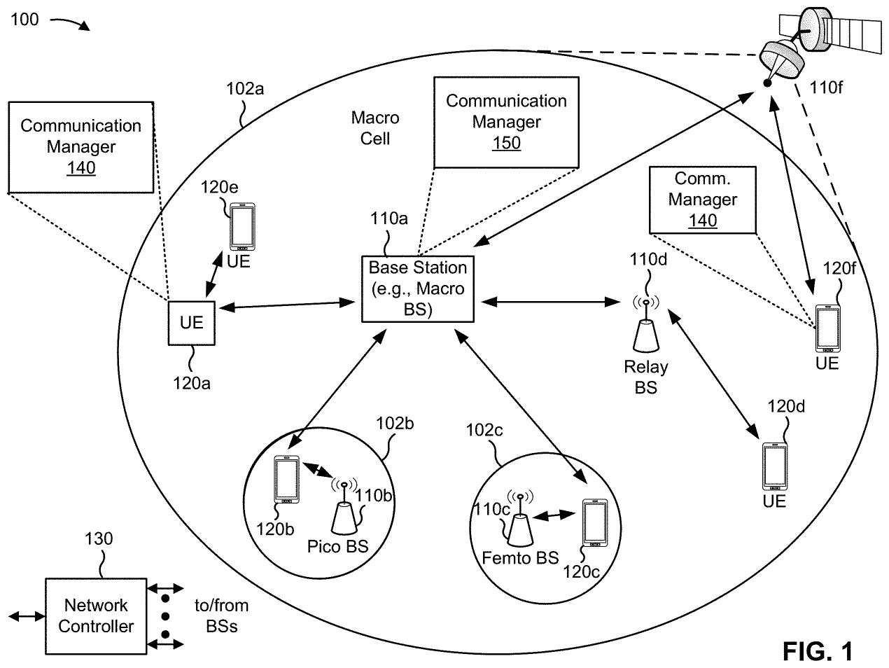

FIG. 1 is a diagram illustrating a wireless network 100 in which aspects of the present disclosure may be practiced. The wireless network 100 may be an LTE network, a 5G or NR network, and/or the like. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

In some examples, as indicated in FIG. 1, a cell may be provided by a base station 110 of an NTN. Such a base station 110 may also referred to as a non-terrestrial base station 110 or a non-terrestrial access point. As used herein, an NTN may refer to a network for which access is provided by or assisted by a non-terrestrial base station 110. In some NTN deployments, a non-terrestrial base station 110 may be located on an airborne platform or a platform in orbit. Examples of such platforms include a satellite (e.g., a LEO satellite, a MEO satellite, a GEO satellite, or the like), a balloon, a dirigible, an airplane, a UAV, a drone, or the like.

In some NTN deployments (e.g., sometimes referred to as a transparent architecture or a bent pipe architecture), a non-terrestrial base station 110 may act as a relay station to relay communications between a UE 120 and a terrestrial base station 110 (e.g., a base station 110 located on the ground or on a tower). In this case, the non-terrestrial base station 110 may perform, for example, frequency translation and/or radio frequency amplification for communications relayed between the UE 120 and a terrestrial base station 110. For example, the UE 120 may transmit an uplink communication to the non-terrestrial base station 110, which may relay the uplink communication to a terrestrial base station 110 (e.g., after performing frequency translation, radio frequency amplification, and/or the like). The terrestrial base station 110 may perform additional processing on the uplink communication and/or may transmit the uplink communication to a core network. As another example, the terrestrial base station 110 may transmit a downlink communication to the non-terrestrial base station 110, which may relay the downlink communication to the UE 120 (e.g., after performing frequency translation, radio frequency amplification, and/or the like). In some aspects, a UE 120 and/or the terrestrial base station 110 may be referred to as a ground station (GS).

A network controller 130 may be coupled to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

As shown in FIG. 1, the UE 120 may include a communication manager 140. As described in more detail elsewhere herein, the communication manager 140 may determine an offset associated with a propagation delay in a network, wherein HARQ feedback is enabled at the UE; and monitor for a retransmission of a downlink communication in the network according to the offset. Additionally, or alternatively, the communication manager 140 may perform one or more other operations described herein.

As shown in FIG. 1, the UE 120 may include a communication manager 140. As described in more detail elsewhere herein, the communication manager 140 may start a timer associated with monitoring for a retransmission of a downlink communication in a network, wherein HARQ feedback is disabled at the UE; and monitor for the retransmission of the downlink communication after starting the timer or after expiration of the timer. Additionally, or alternatively, the communication manager 140 may perform one or more other operations described herein.

As shown in FIG. 1, the base station 110 may include a communication manager 150. As described in more detail elsewhere herein, the communication manager 150 may determine an offset associated with a propagation delay in a network, wherein HARQ feedback is enabled at a UE; schedule a retransmission of a downlink communication to the UE based at least in part on the offset; and transmit the retransmission of the downlink communication based at least in part on scheduling the retransmission of the downlink communication. Additionally, or alternatively, the communication manager 150 may perform one or more other operations described herein.

As shown in FIG. 1, the base station 110 may include a communication manager 150. As described in more detail elsewhere herein, the communication manager 150 may start a timer associated with transmitting a retransmission of a downlink communication to a UE in a network, wherein HARQ feedback is disabled at the UE; and transmit the retransmission of the downlink communication after starting the timer or after expiration of the timer. Additionally, or alternatively, the communication manager 150 may perform one or more other operations described herein.

As indicated above, FIG. 1 is provided merely as an example. Other examples may differ from what is described with regard to FIG. 1.

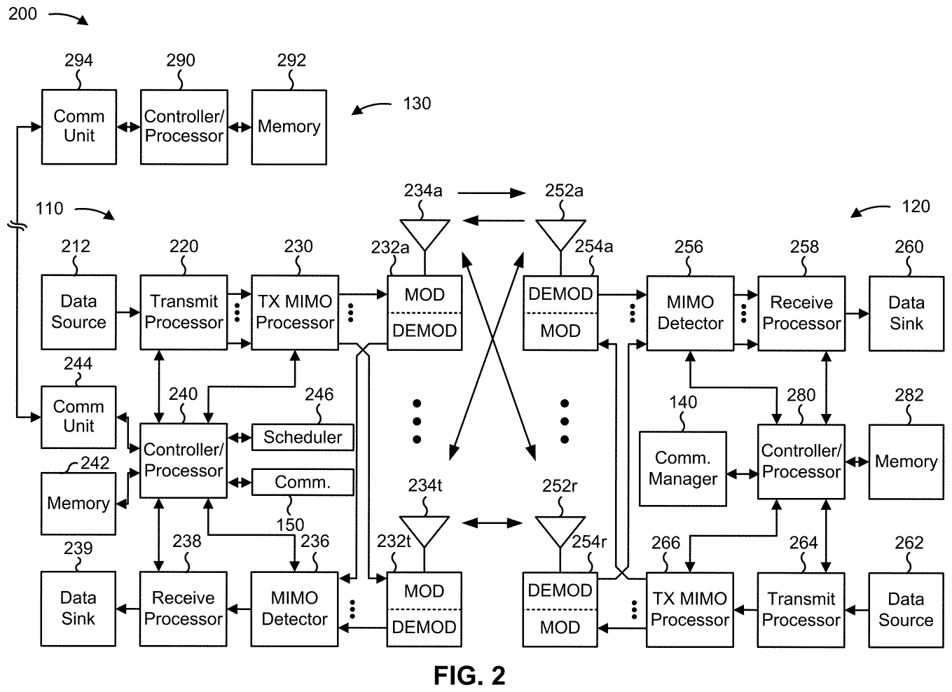

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

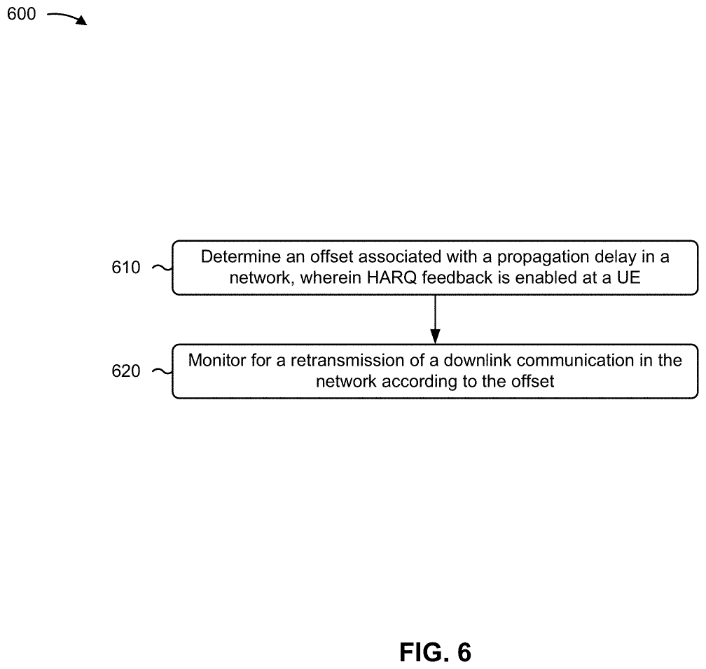

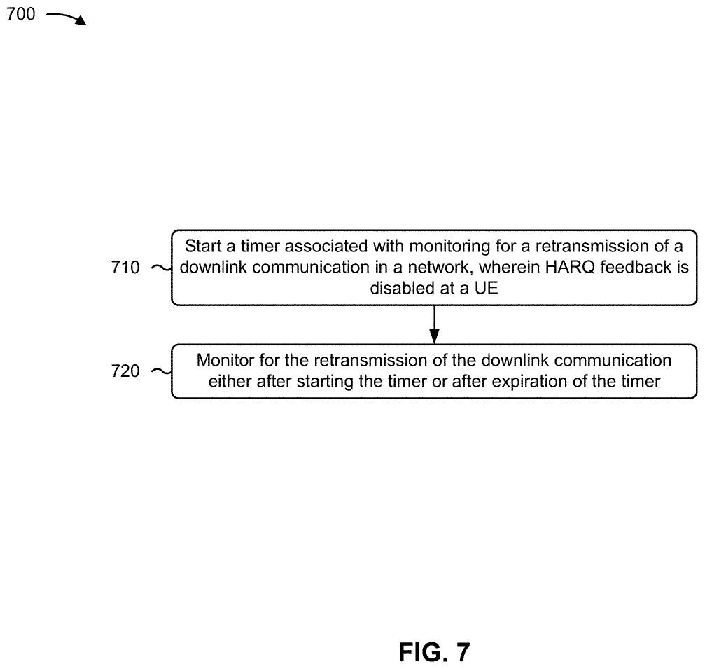

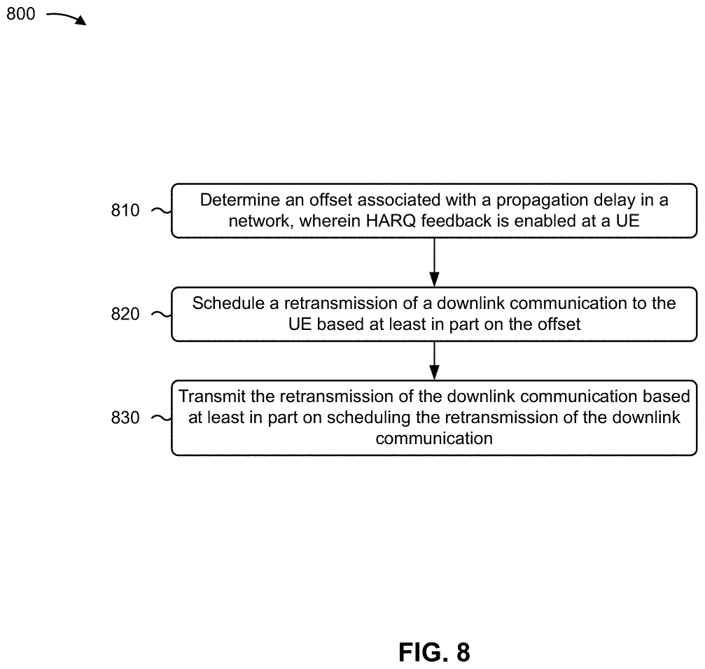

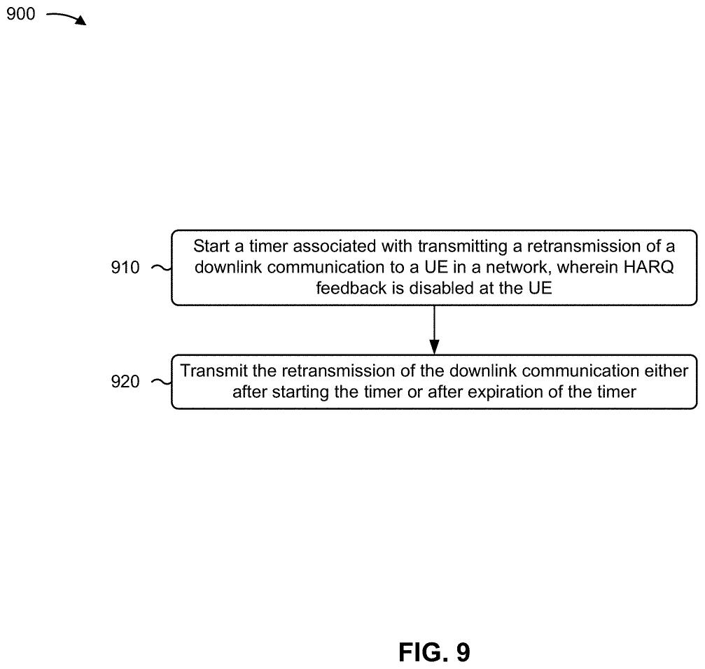

Controller/processor 240 of base station 110, controller/processor 280 of UE 120, and/or any other component(s) of FIG. 2 may perform one or more techniques associated with DRX operation in an NTN, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. Memories 242 and 282 may store data and program codes for base station 110 and UE 120, respectively. A scheduler 246 may schedule UEs for data transmission on the downlink and/or uplink.

In some aspects, the UE 120 may include means for determining an offset associated with a propagation delay in a network, wherein HARQ feedback is enabled at the UE; means for monitoring for a retransmission of a downlink communication in the network according to the offset; and/or the like. Additionally, or alternatively, the UE 120 may include means for performing one or more other operations described herein. In some aspects, such means may include the communication manager 140. Additionally, or alternatively, such means may include one or more components of the UE 120 described in connection with FIG. 2.

In some aspects, the UE 120 may include means for starting a timer associated with monitoring for a retransmission of a downlink communication in a network, wherein HARQ feedback is disabled at the UE; means for monitoring for the retransmission of the downlink communication after starting the timer or after expiration of the timer; and/or the like. Additionally, or alternatively, the UE 120 may include means for performing one or more other operations described herein. In some aspects, such means may include the communication manager 140. Additionally, or alternatively, such means may include one or more components of the UE 120 described in connection with FIG. 2.

In some aspects, the base station 110 may include means for determining an offset associated with a propagation delay in a network, wherein HARQ feedback is enabled at a UE; means for scheduling a retransmission of a downlink communication to the UE based at least in part on the offset; means for transmitting the retransmission of the downlink communication based at least in part on scheduling the retransmission of the downlink communication; and/or the like. Additionally, or alternatively, the base station 110 may include means for performing one or more other operations described herein. In some aspects, such means may include the communication manager 150. Additionally, or alternatively, such means may include one or more components of the base station 110 described in connection with FIG. 2.

In some aspects, the base station 110 may include means for starting a timer associated with transmitting a retransmission of a downlink communication to a UE in a network, wherein HARQ feedback is disabled at the UE; means for transmitting the retransmission of the downlink communication after starting the timer or after expiration of the timer; and/or the like. Additionally, or alternatively, the base station 110 may include means for performing one or more other operations described herein. In some aspects, such means may include the communication manager 150. Additionally, or alternatively, such means may include one or more components of the base station 110 described in connection with FIG. 2.

As indicated above, FIG. 2 is provided merely as an example. Other examples may differ from what is described with regard to FIG. 2.

As described above, an NTN may utilize non-terrestrial base stations (e.g., non-terrestrial base stations 110) for providing or assisting UEs (e.g., UEs 120) with access to a core network. A non-terrestrial base station may be located on a platform, which may be, for example, a satellite (e.g., a LEO satellite, a MEO satellite, a GEO satellite, or the like), a balloon, a dirigible, an airplane, a UAV, a drone, or the like.

In an NTN system, propagation delay may be significant due to a relatively large distance between a UE and a non-terrestrial base station and/or a relatively large distance between a terrestrial base station and the non-terrestrial base station. A total one-way propagation delay when a non-terrestrial base station that serves as a relay between a terrestrial base station and a UE may be equal to a propagation delay between the UE and the non-terrestrial base station plus a propagation delay between the non-terrestrial base station and the terrestrial base station. A total one-way propagation delay when a non-terrestrial base station provides access for the UE may be equal to a propagation delay between the UE and the non-terrestrial base station. In some cases, the UE may estimate the propagation delay between the non-terrestrial base station and the UE (e.g., using a Global Navigation Satellite System (GNSS) capability), but may not be able to estimate the propagation delay between the terrestrial base station and the non-terrestrial base station (e.g., due to a speed of the non-terrestrial base station or handover of a feeder link). Therefore, in some cases, the non-terrestrial base station may provide the UE with information indicating the propagation delay between the terrestrial base station and the non-terrestrial base station.

In some cases, due to the propagation delay in an NTN system, it may be desirable to disable HARQ feedback so as to avoid stalling of a HARQ process. In a case in which HARQ feedback is disabled, operation of one or more DRX timers should account for the disabling of HARQ feedback. Alternatively, when HARQ feedback is enabled in an NTN scenario, operation of the one or more DRX timers should account for the propagation delay present in the NTN system (e.g., so as to prevent stalling of the HARQ process).

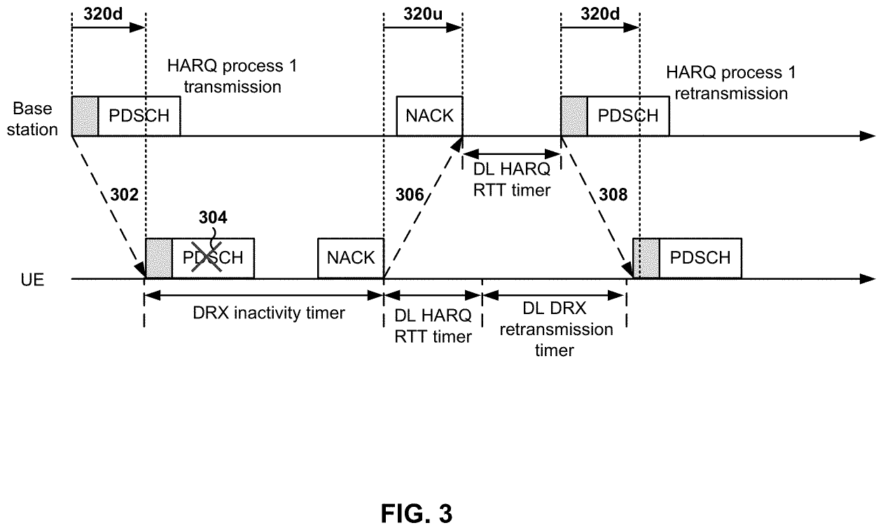

FIG. 3 is a diagram illustrating an example of conventional DRX operation for a HARQ process in an NTN scenario. As shown by reference 302, a base station transmits an initial transmission of a downlink communication to a UE. In FIG. 3, propagation delays associated with downlink communications from the base station to the UE are time periods identified with reference 320d. Here, upon detecting data intended for the UE (e.g., based on monitoring a physical downlink control channel (PDCCH)), the UE starts a DRX inactivity timer. The DRX inactivity timer is a timer that indicates a length of time that the UE should remain ‘ON’ after reception of the PDCCH.

In this example, as indicated by reference 304, the UE fails to successfully decode the downlink communication (e.g., a physical downlink shared channel (PDSCH) communication) intended for the UE or otherwise is unable to successfully receive the downlink communication and, as shown by reference 306, transmits a negative acknowledgment (NACK) to the base station. In FIG. 3, a propagation delay associated with an uplink communication (e.g., a NACK) from the UE to the base is a time period identified with reference 320u. As shown, after transmitting the NACK and after expiration of the DRX inactivity timer, the UE starts a downlink HARQ round trip time (RTT) timer. The downlink HARQ RTT timer indicates a minimum length of time (e.g., a minimum number of transmission time intervals (TTIs)) before a retransmission of a downlink communication is to be expected by the UE. A value of the downlink HARQ RTT timer is configured at the UE by the base station. In some cases, the UE may be configured to operate in a sleep state while the downlink HARQ RTT timer is running (i.e., from the start of the downlink HARQ RTT timer until expiration of the downlink HARQ RTT timer), meaning that the UE does not monitor a PDCCH during this time. As further shown, based at least in part on receiving the NACK, the base station also starts a downlink HARQ RTT timer. Here, a value of the downlink HARQ RTT timer at the base station is the same as the value of the downlink HARQ RTT timer at the UE.

As shown, after expiration of the downlink HARQ RTT timer, the UE starts a downlink DRX retransmission timer. The downlink DRX retransmission timer indicates a maximum length of time (e.g., a maximum number of consecutive PDCCH subframes) the UE should remain active to wait for an incoming retransmission of the downlink communication. In other words, while the downlink DRX retransmission timer is running, the UE may resume PDCCH reception so as to be able to receive a retransmission of the downlink communication.

As shown by reference 308, the base station transmits the retransmission of the downlink communication after expiration of the downlink HARQ RTT timer at the base station. However, as shown in FIG. 3, when this DRX operation is used for a HARQ process in an NTN scenario, the retransmission of the downlink communication may arrive at the UE after expiration of the downlink DRX retransmission timer. Here, when the UE ceases monitoring the PDCCH after expiration of the downlink DRX retransmission timer, the UE fails to receive the retransmission of the downlink communication, thereby stalling the HARQ process.

Some aspects described herein provide technique and apparatuses for DRX operation in an NTN system. For example, the techniques and apparatuses described herein provide operation of one or more DRX timers and scheduling of a retransmission in a manner that accounts for propagation delay (when HARQ feedback is enabled). As an example, in an aspect in which HARQ feedback is enabled at a UE, the UE may determine an offset associated with a propagation delay in a network (e.g., an NTN network). The UE may then monitor for a retransmission of a downlink communication in the network according to the offset. In this example, the base station may determine the offset associated with the propagation delay in the network (e.g., in a manner similar to that of the UE, may schedule a retransmission of the downlink communication to the UE based at least in part on the offset, and may transmit the retransmission of the downlink communication based at least in part on scheduling the retransmission of the downlink communication, accordingly. Furthermore, the techniques and apparatuses described herein describe operation of one or more DRX timers in a manner that accounts for disabling of HARQ feedback. As an example, in an aspect in which HARQ feedback is disabled at a UE, the UE may start a timer associated with monitoring for a retransmission of a downlink communication in a network, and may monitoring for the retransmission of the downlink communication after starting the timer or after expiration of the timer. In this example, the base station may start a timer associated with transmitting the retransmission of the downlink communication to the UE (e.g., in a similar manner to the UE), and may transmit the retransmission of the downlink communication after starting the timer or after expiration of the timer. Notably, while the techniques and apparatuses described herein are described in the context of an NTN system, these techniques and apparatuses may be applied in another type of system in which propagation delay may occur.

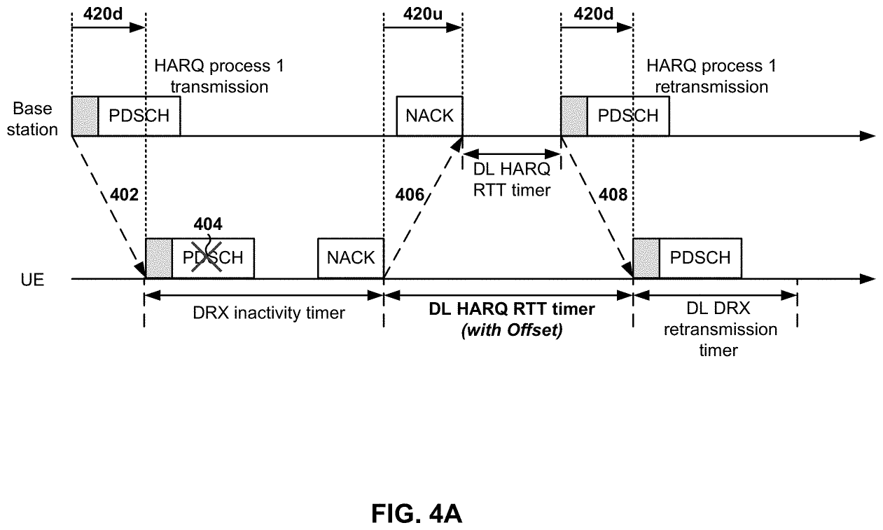

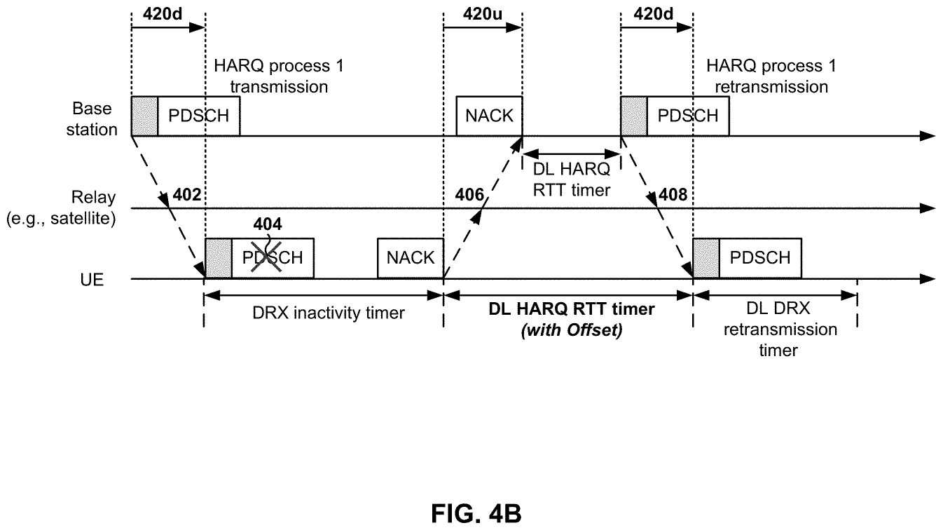

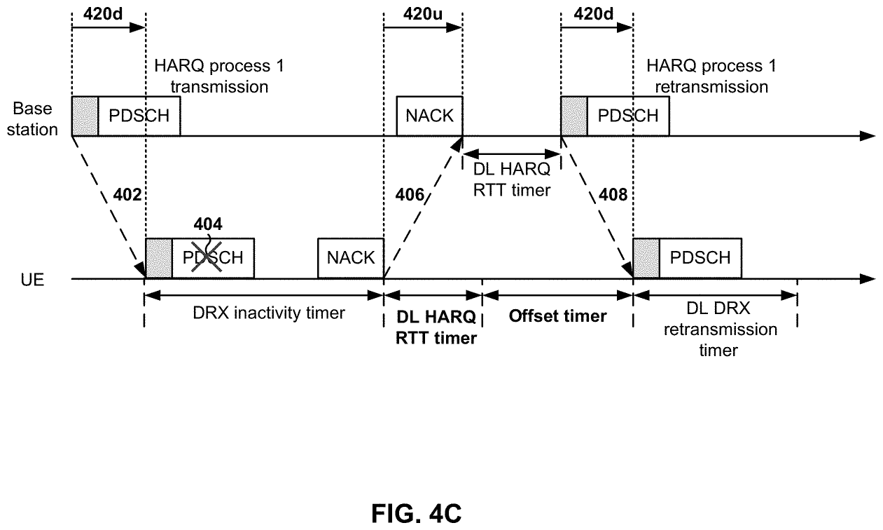

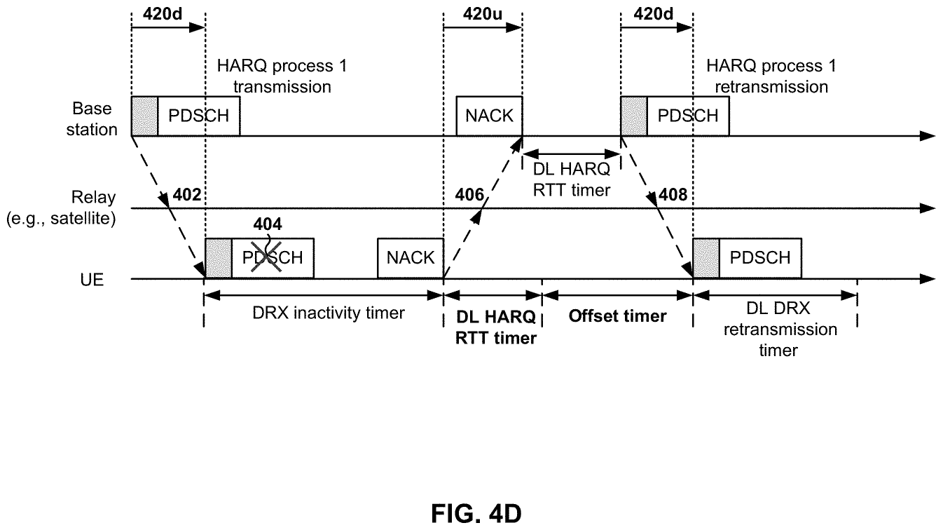

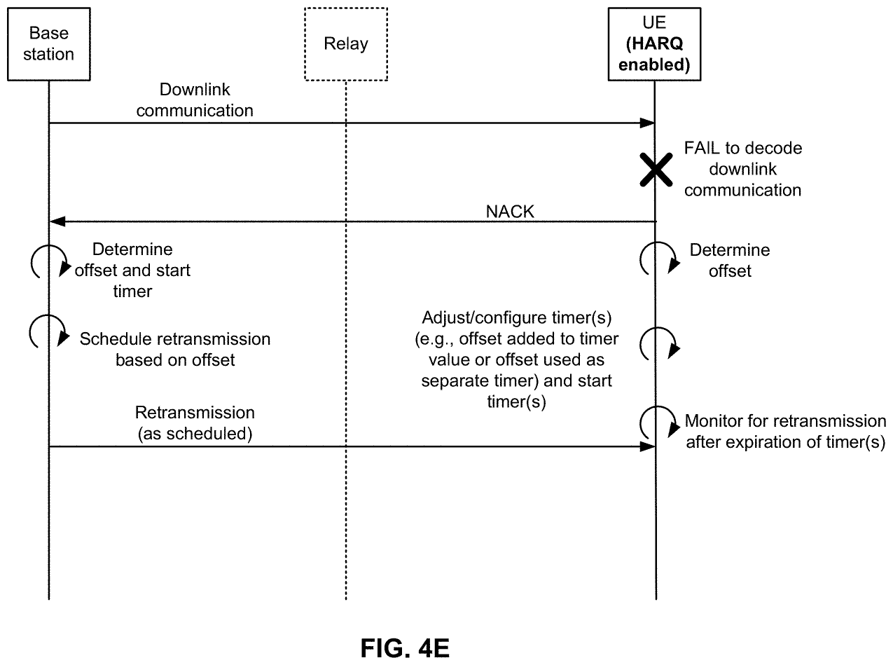

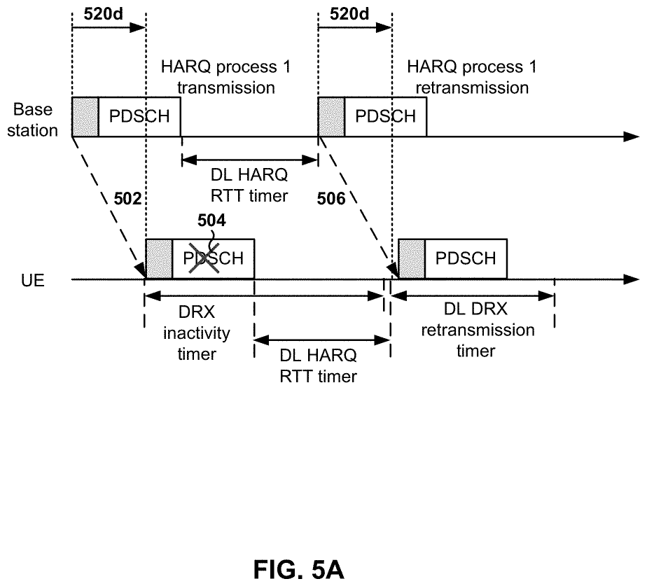

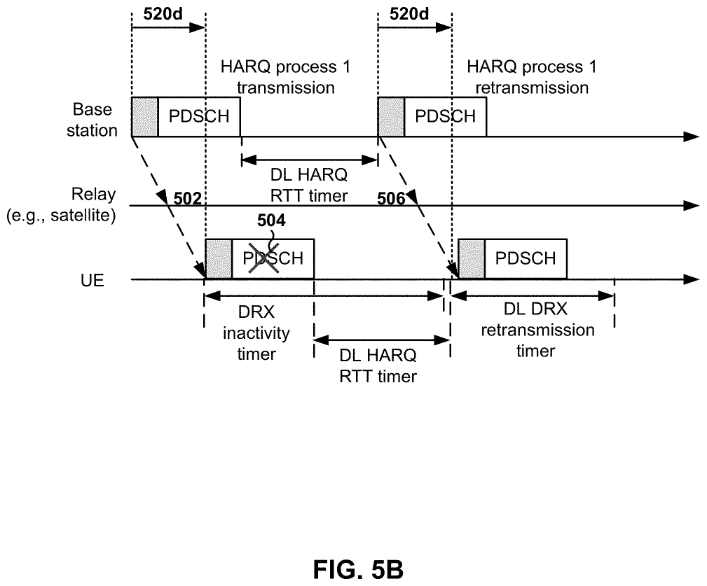

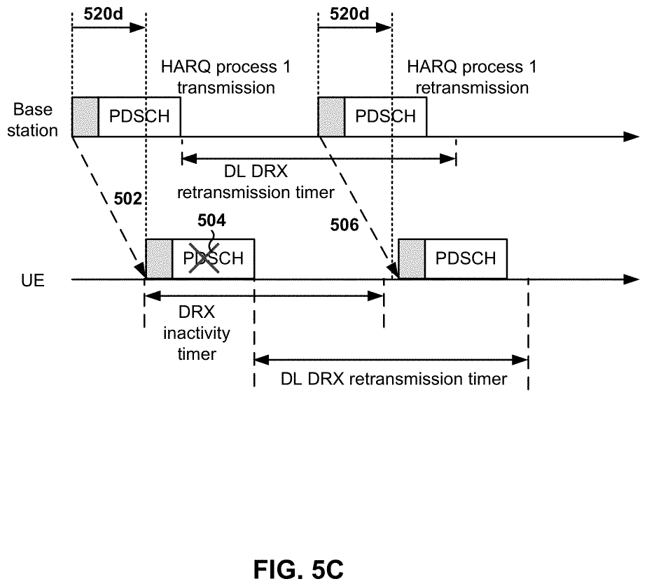

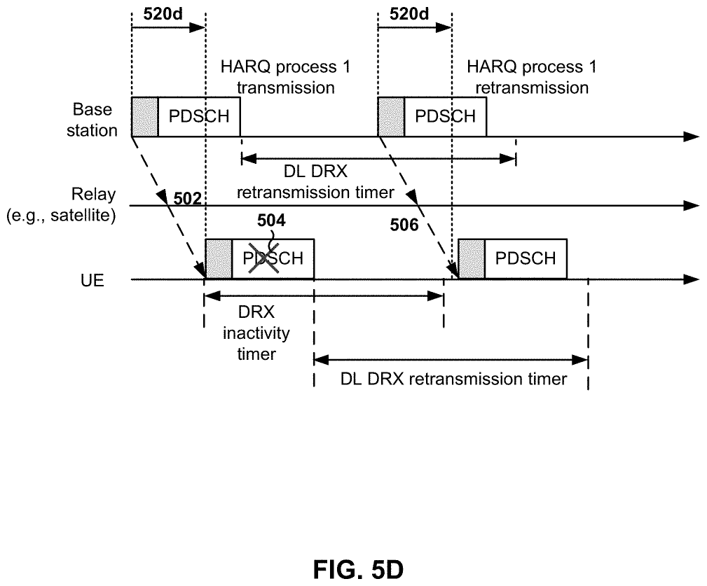

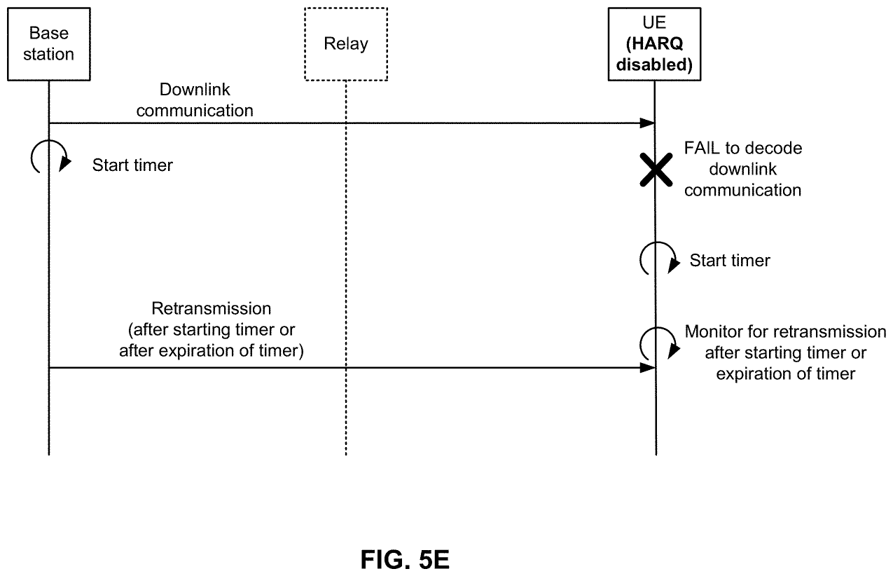

FIGS. 4A-4E and FIGS. 5A-5E are diagrams illustrating examples associated with DRX operation in an NTN, in accordance with various aspects of the present disclosure.

FIGS. 4A-4E are diagrams illustrating examples associated with DRX operation in an NTN when HARQ feedback is enabled. FIGS. 4A and 4B illustrate examples associated with a first example of DRX operation in an NTN when HARQ feedback is enabled. FIG. 4A illustrates the first example of DRX operation when a base station is a non-terrestrial base station (e.g., a non-terrestrial base station 110) or is a terrestrial base station (e.g., a terrestrial base station 110 that does not utilize a non-terrestrial base station as a relay), while FIG. 4B illustrates the first example of DRX operation when the base station is a terrestrial base station (e.g., a terrestrial base station 110) and a non-terrestrial base station (e.g., a non-terrestrial base station 110) acts as a relay. FIGS. 4C and 4D illustrate examples associated with a second example of DRX operation in an NTN when HARQ feedback is enabled. FIG. 4C illustrates the second example of DRX operation when the base station is a non-terrestrial base station or is a terrestrial base station that does not utilize a non-terrestrial base station as a relay, while FIG. 4D illustrates the second example of DRX operation when the base station is a terrestrial base station and a non-terrestrial base station acts as a relay.

With reference to FIGS. 4A-4D, and as shown by reference 402, the base station may transmit an initial transmission of a downlink communication to a UE (e.g., a UE 120). Here, upon detecting data intended for the UE, the UE may start a DRX inactivity timer. As indicated by reference 404, the UE may fail to successfully decode the downlink communication intended for the UE or may be otherwise unable to successfully receive the downlink communication and, as shown by reference 406, may transmit a NACK to the base station. In FIGS. 4A-4D, propagation delays associated with downlink communications from the base station to the UE are time periods identified with reference 420d, and a propagation delay associated with an uplink communication (e.g., a NACK) from the UE to the base is a time period identified with reference 420u.

In some aspects, when HARQ feedback is enabled at the UE, the UE and/or the base station may determine an offset associated with a propagation delay in the NTN. In some aspects, the offset is a value that may be used in association with accounting for the propagation delay in the NTN.

In some aspects, the offset may be determined based at least in part on a result of doubling an estimated one-way propagation delay associated with the NTN. For example, when the base station is a non-terrestrial base station (as in the examples shown in FIGS. 4A and 4C), the UE or the non-terrestrial base station may estimate the propagation delay between the UE and the non-terrestrial base station. Here, the propagation delay between the UE and the non-terrestrial base station is the total one-way propagation delay. In this example, the UE or the non-terrestrial base station may double the propagation delay between the UE and the non-terrestrial base station, a result of which is the offset.

As another example, when the base station is a terrestrial base station (as in the examples shown in FIGS. 4B and 4D), the UE may estimate the propagation delay between the UE and the non-terrestrial base station acting as the relay, and may receive, from the non-terrestrial base station, information indicating the propagation delay between the terrestrial base station and the non-terrestrial base station. The UE may sum the propagation delay between the non-terrestrial base station and the UE and the propagation delay between the terrestrial base station and the non-terrestrial base station, a result of which is the total one-way propagation delay. In this example, the UE may double the result of the summing, a result of which is the offset. Similarly, the non-terrestrial base station may estimate the propagation delay between the UE and the non-terrestrial base station and may estimate or determine the propagation delay between the terrestrial base station and the non-terrestrial base station. The non-terrestrial base station may sum the propagation delay between the non-terrestrial base station and the UE and the propagation delay between the terrestrial base station and the non-terrestrial base station, a result of which is the total one-way propagation delay. In this example, the non-terrestrial base station may double the result of the summing, a result of which is the offset.

In some aspects, the UE may add the offset to a timer value, and a result of adding the offset to the timer value may be a downlink HARQ RTT timer value. That is, in some aspects, a length of the downlink HARQ RTT timer may be a configured value plus the offset (rather than a length of the downlink HARQ RTT timer being solely the configured value, as in the conventional case described above). Put another way, in some aspects, the offset may be combined with a configured timer value, a result of which is a value of the downlink HARQ RTT timer. Examples of such a scenario are illustrated in FIGS. 4A and 4B. As shown in FIGS. 4A and 4B, the UE may start the downlink HARQ RTT timer based at least in part on the determined value for the downlink HARQ RTT timer and may monitor for the retransmission of the downlink communication after expiration of the downlink HARQ RTT timer. In some aspects, the UE may refrain from monitoring the PDCCH while the downlink HARQ RTT timer is running (e.g., for a length of time corresponding to the configured value plus the offset). Alternatively, in some aspects, the UE may operate according to a configured DRX state (e.g., DRX active, DRX inactive, or the like) while the downlink HARQ RTT timer is running (e.g., from a time of the starting of the downlink HARQ RTT timer to a time of the expiration of the downlink HARQ RTT timer). Alternatively, in some aspects, the UE may operate according to a configured DRX cycle (e.g., an existing DRX cycle, a mini-DRX cycle, or the like) while the downlink HARQ RTT timer is running (e.g., from a time of the starting of the downlink HARQ RTT timer to a time of the expiration of the downlink HARQ RTT timer). In some aspects (e.g., when DRX is not configured), the UE may operate in a DRX ON mode from the time of starting the downlink HARQ RTT timer to a time of expiration of the downlink HARQ RTT timer (e.g., such that the UE monitors PDCCH during this time).

In some aspects, the offset may be utilized separately from the downlink HARQ RTT timer. For example, in some aspects, the UE may configure an offset timer based at least in part on the offset. In some aspects, the offset timer may be used to delay a start of a downlink DRX retransmission timer. Examples of such a scenario are illustrated in FIGS. 4C and 4D. As shown in FIGS. 4C and 4D, the UE may start a downlink HARQ RTT timer (e.g., based at least in part on a configured downlink HARQ RTT timer value, which in some cases may be zero) after transmitting the NACK. Here, the UE may start the offset timer after expiration of the downlink HARQ RTT timer and may monitor for the retransmission of the downlink communication after expiration of the offset timer. In some aspects, the UE may refrain from monitoring the PDCCH while the downlink HARQ RTT timer is running. In some aspects, the UE may operate according to a configured DRX state while the offset timer is running (e.g., from a time of the starting of the offset timer to a time of the expiration of the offset timer). Alternatively, the UE may operate in a DRX sleep mode while the offset timer is running (e.g., from a time of the starting of the offset timer to a time of the expiration of the offset timer). Alternatively, in some aspects, the UE may operate according to a configured DRX cycle (e.g., an existing DRX cycle, a mini-DRX cycle, or the like) while the offset timer is running (e.g., from a time of the starting of the offset timer to a time of the expiration of the offset timer) In some aspects, the offset timer may be used to delay a start of the downlink HARQ RTT timer (e.g., rather than the downlink DRX retransmission timer). In such a case, the UE may start the offset timer after transmitting the NACK and may start the downlink HARQ RTT timer after expiration of the offset timer.

In some aspects, the UE may start the downlink DRX retransmission timer after expiration of the downlink HARQ RTT timer (e.g., as shown in FIGS. 4A and 4B) or after expiration of the offset timer (e.g., as shown in FIGS. 4C and 4D). The UE may then monitor the PDCCH while the downlink DRX retransmission timer is running so as to be able to receive a retransmission of the downlink communication.

As further shown in FIGS. 4A-4D, based at least in part on receiving the NACK, the base station may start a downlink HARQ RTT timer. Here, a value of the downlink HARQ RTT timer at the base station may correspond to the value of the downlink HARQ RTT timer configured at the UE.

In some aspects, the base station may determine the offset, as described above, and may schedule the retransmission of the downlink communication based at least in part on the offset. For example, the base station may determine the offset, and may schedule the retransmission of the downlink communication while taking the offset into account (e.g., such that the base station expects the retransmission to be received by the UE before expiration of a downlink DRX retransmission timer at the UE). In some aspects, the base station may schedule the retransmission of the downlink communication further based at least in part on the configured DRX state of the UE. For example, the base station may determine the configured DRX state of the UE, and may schedule the retransmission of the downlink communication while taking the configured DRX state into account (e.g., such that the base station expects the retransmission to be received by the UE while the UE operates in a DRX state that allows the UE to monitor the PDCCH).

As shown by reference 408 in FIGS. 4A-4D, the base station may transmit the retransmission of the downlink communication based at least in part on scheduling the retransmission (e.g., after expiration of the downlink HARQ RTT timer at the base station). Notably, in the examples shown in FIGS. 4A-4D, because the offset was accounted for in DRX timers at the UE and was accounted for in scheduling of the retransmission at the base station, the retransmission of the downlink communication may arrive at the UE before expiration of the downlink DRX retransmission timer at the UE. Thus, the UE may be able to receive the retransmission of the downlink communication for the HARQ process.

FIG. 4E is a call flow diagram illustrating an example call flow corresponding to the operations described above in connection with FIGS. 4A-4D. As shown in FIG. 4E, the base station may transmit an initial transmission of a downlink communication to the UE. As further shown in FIG. 4E, the UE may fail to successfully decode the downlink communication intended for the UE or may be otherwise unable to successfully receive the downlink communication. Therefore, since HARQ feedback is enabled at the UE, the UE may transmit, and the base station may receive, a NACK associated with the downlink communication, as shown. As further shown in FIG. 4E, the UE and the base station may determine an offset associated with a propagation delay between the UE and the base station. In some aspects, as shown, the base station may start a timer (e.g., a downlink HARQ RTT timer) and schedule a retransmission of the downlink communication based at least in part on the offset, as described above. As further shown, the UE may adjust or configure one or more timers based at least in part on the offset and may start the one or more timers. For example, the UE may adjust a downlink HARQ RTT timer by adding the offset to a value of the downlink HARQ RTT timer (i.e., the UE may adjust the downlink HARQ RTT timer value according to the offset) and may start the downlink HARQ RTT timer, as described above. As another example, the UE may configure an offset timer based on the offset (e.g., such that the offset is used as a value of the offset timer). Here, the UE may start a downlink HARQ RTT timer, and then start the offset timer upon expiration of the downlink HARQ RTT timer, as described above. As further shown, the UE may monitor for the retransmission after expiration of the one or more timers (e.g., after expiration of the downlink HARQ RTT timer when the UE adds the offset to the downlink HARQ RTT timer value, or after expiration of the offset timer when the UE configures the separate offset timer). As shown, the base station may transmit the retransmission as scheduled and, when the base station transmits the retransmission during the time period that the UE is monitoring for the retransmission, the UE may receive the retransmission.

As indicated above, FIGS. 4A-4E are provided as examples. Other examples may differ from what is described with respect to FIGS. 4A-4E.

FIGS. 5A-5E are diagrams illustrating examples associated with DRX operation in an NTN when HARQ feedback is disabled, in accordance with various aspects of the present disclosure. FIGS. 5A and 5B illustrate examples associated with a first example of DRX operation in an NTN when HARQ feedback is disabled. FIG. 5A illustrates the first example of DRX operation when a base station is a non-terrestrial base station (e.g., a non-terrestrial base station 110) or is a terrestrial base station (e.g., a terrestrial base station 110 that does not utilize a non-terrestrial base station as relay), while FIG. 5B illustrates the first example of DRX operation when the base station is a terrestrial base station (e.g., a terrestrial base station 110) and a non-terrestrial base station (e.g., a non-terrestrial base station 110) acts as a relay. FIGS. 5C and 5D illustrate examples associated with a second example of DRX operation in an NTN when HARQ feedback is disabled. FIG. 5C illustrates the second example of DRX operation when the base station is a non-terrestrial base station or is a terrestrial base station (e.g., that does not utilize a non-terrestrial base station as a relay), while FIG. 5D illustrates the second example of DRX operation when the base station is a terrestrial base station and a non-terrestrial base station acts as a relay.

With reference to FIGS. 5A-5D, and as shown by reference 502, the base station may transmit an initial transmission of a downlink communication to a UE (e.g., a UE 120). Here, upon detecting data intended for the UE, the UE may start a DRX inactivity timer. As indicated by reference 504, the UE may fail to successfully decode the downlink communication intended for the UE or may be otherwise unable to successfully receive the downlink communication. Here, because HARQ feedback is disabled, the UE does not transmit a NACK to the base station. In FIGS. 5A-5D, propagation delays associated with downlink communication from the base station to the UE are time periods identified with reference 520d.

In some aspects, the UE may start a timer associated with monitoring for a retransmission of the downlink communication. For example, the UE may start the timer at an end of the downlink communication (e.g., based at least in part on failing to decode the downlink communication). Similarly, the base station may start a timer associated with transmitting a retransmission of the downlink communication to the UE (e.g., at an end of the downlink communication).

In some aspects, as shown in FIGS. 5A and 5B, the timer may be a downlink HARQ RTT timer. In some aspects, a value for the downlink HARQ RTT timer may be configured at the UE by the base station. In some aspects, the value for the downlink HARQ RTT timer is permitted to be set to zero. As shown, in some aspects, the UE or the base station may start the downlink HARQ RTT timer at an end of the initial transmission of the downlink communication. In some aspects, the UE or the base station may start the downlink HARQ RTT timer at the end of the initial transmission only. Alternatively, in some aspects, the UE or the base station may start the downlink HARQ RTT timer at the end of the initial transmission and at an end of each of a plurality of retransmissions of the downlink communication (e.g., such that the downlink HARQ RTT timer is started at the end of each retransmission of the downlink communication). In some aspects, a maximum number of times the downlink HARQ RTT timer is restarted based at least in part on retransmitting the downlink communication may be configured via dedicated signaling.

In some aspects, as further shown in FIGS. 5A and 5B, the UE or the base station may start a downlink DRX retransmission timer upon expiration of the downlink HARQ RTT timer. In some aspects, the UE may monitor for the retransmission of the downlink communication while the downlink DRX retransmission timer is running (e.g., from a time of starting the downlink DRX retransmission timer to a time of expiration of the downlink DRX retransmission timer). As shown by reference 506, the base station may transmit the retransmission of the downlink communication after expiration of the downlink HARQ RTT timer on the base station (e.g., while the downlink DRX retransmission timer is running on the UE).

In some aspects, the UE or the base station may be configured to start the downlink DRX retransmission timer after the initial transmission only. In such a case, retransmissions of the downlink communication by the base station should occur before expiration of the downlink DRX retransmission timer. Alternatively, in some aspects, the UE or the base station may be configured to start the downlink DRX retransmission timer after the initial transmission and after each retransmission of the downlink communication (e.g., such that the downlink DRX retransmission timer is restarted after each retransmission of the downlink communication). In some aspects, a maximum number of times the downlink DRX retransmission timer is restarted based at least in part on retransmitting the downlink communication may be configured via dedicated signaling.

In some aspects, as shown in FIGS. 5C and 5D, the timer may be a downlink DRX retransmission timer. In such a case, the downlink HARQ RTT timer may not be utilized. In some aspects, the UE or the base station may be configured to start the downlink DRX retransmission timer at or after an end of the initial transmission of the downlink communication. In some aspects, the UE may monitor for one or more retransmissions of the downlink communication while the downlink DRX timer is running on the UE (e.g., from a time of starting the downlink DRX retransmission timer to a time of expiration of the downlink DRX retransmission timer). Similarly, the base station may be configured to transmit the one or more retransmissions of the downlink communication before expiration of the downlink DRX timer (e.g., in a time window from a time of starting the downlink DRX retransmission timer to a time of expiration of the downlink DRX retransmission timer). As shown by reference 506, the base station may transmit the retransmission of the downlink communication before expiration of the downlink DRX timer (e.g., such that the UE receives the retransmission of the downlink communication while the downlink DRX retransmission timer is running on the UE).

In some aspects, the UE or the base station may start the downlink DRX retransmission timer at or after the end of the initial transmission only. In such a case, retransmissions of the downlink communication by the base station should occur before expiration of the downlink DRX retransmission timer. Alternatively, in some aspects, the UE or the base station may start the downlink DRX retransmission timer at or after the end of the initial transmission and at or after an end of each of a plurality of retransmissions of the downlink communication. In some aspects, a maximum number of times the downlink DRX retransmission timer is restarted based at least in part on retransmitting the downlink communication may be configured via dedicated signaling.

Notably, in the examples shown in FIGS. 5A-5D, the retransmission of the downlink communication may arrive at the UE before expiration of the downlink DRX retransmission timer at the UE. Furthermore, because HARQ feedback is disabled, propagation delay is reduced.

FIG. 5E is a call flow diagram illustrating an example call flow corresponding to the operations described above in connection with FIGS. 5A-5D. As shown in FIG. 5E, the base station may transmit an initial transmission of a downlink communication to the UE. In some aspects, since HARQ feedback is disabled at the UE, the base station may start a timer (e.g., a downlink HARQ RTT timer or a downlink DRX retransmission timer, as described above) after transmitting the downlink communication. As further shown in FIG. 5E, the UE may fail to successfully decode the downlink communication intended for the UE or may be otherwise unable to successfully receive the downlink communication. Here, since HARQ feedback is disabled at the UE, the UE does not transmit a NACK associated with the downlink communication. Rather, as shown in FIG. 5E, the UE may start a timer (e.g., a downlink HARQ RTT timer or a downlink DRX retransmission timer). As further shown, the base station may transmit a retransmission after starting the timer (e.g., when the timer is the downlink DRX retransmission timer) or upon expiration of the timer (e.g., when the timer is the downlink HARQ RTT timer). As further shown, the UE may monitor for the retransmission after starting its timer (e.g., when the timer is the downlink DRX retransmission timer) or after expiration of its timer (e.g., when the timer is the downlink HARQ RTT timer). Here, when the base station transmits the retransmission during the time period that the UE is monitoring for the retransmission, the UE may receive the retransmission.

As indicated above, FIGS. 5A-5E are provided as examples. Other examples may differ from what is described with respect to FIGS. 5A-5E.

FIG. 6 is a diagram illustrating an example process 600 performed, for example, by a UE, in accordance with various aspects of the present disclosure. Example process 600 is an example where the UE (e.g., UE 120 and/or the like) performs operations associated with DRX operation in an NTN.

As shown in FIG. 6, in some aspects, process 600 may include determining an offset associated with a propagation delay in a network (block 610). For example, the UE (e.g., using communication manager 140, receive processor 258, transmit processor 264, controller/processor 280, memory 282, and/or the like) may determine an offset associated with a propagation delay in a network, as described above. In some aspects, HARQ feedback is enabled at the UE.

As further shown in FIG. 6, in some aspects, process 600 may include monitoring for a retransmission of a downlink communication in the network according to the offset (block 620). For example, the UE (e.g., using communication manager 140, receive processor 258, transmit processor 264, controller/processor 280, memory 282, and/or the like) may monitor for a retransmission of a downlink communication in the network according to the offset, as described above.

Process 600 may include additional aspects, such as any single aspect or any combination of aspects described below and/or in connection with one or more other processes described elsewhere herein.

In a first aspect, the network is a non-terrestrial network.

In a second aspect, alone or in combination with the first aspect, the offset is determined based at least in part on a result of doubling an estimated one-way propagation delay associated with the network.

In a third aspect, alone or in combination with one or more of the first and second aspects, the offset is added to a timer value, a result of adding the offset to the timer value being a downlink HARQ RTT timer value.

In a fourth aspect, alone or in combination with one or more of the first through third aspects, process 600 includes starting a downlink HARQ RTT timer based at least in part on the downlink HARQ RTT timer value, and monitoring for the retransmission of the downlink communication after expiration of the downlink HARQ RTT timer.

In a fifth aspect, alone or in combination with one or more of the first through fourth aspects, the UE operates according to a configured discontinuous reception cycle from a time of the starting of the downlink HARQ RTT timer to a time of the expiration of the downlink HARQ RTT timer.

In a sixth aspect, alone or in combination with one or more of the first through fifth aspects, an offset timer is configured based at least in part on the offset, the offset timer being used to delay a start of a downlink DRX retransmission timer.

In a seventh aspect, alone or in combination with one or more of the first through sixth aspects, process 600 includes starting a downlink HARQ RTT based at least in part on a configured downlink HARQ RTT timer value, starting the offset timer after expiration of the downlink HARQ RTT timer, and monitoring for the retransmission of the downlink communication after expiration of the offset timer. In some aspects, the configured downlink HARQ RTT timer value zero (e.g., such that the timer has a length of zero).

In an eighth aspect, alone or in combination with one or more of the first through seventh aspects, the UE operates according to a configured discontinuous reception cycle from a time of the starting of the offset timer to a time of the expiration of the offset timer.

In a ninth aspect, alone or in combination with one or more of the first through eighth aspects, the UE operates in a discontinuous reception sleep mode from a time of the starting of the offset timer to a time of the expiration of the offset timer.

In a tenth aspect, alone or in combination with one or more of the first through ninth aspects, the UE may operate in a DRX ON mode from a time of starting a downlink HARQ RTT timer to a time of expiration of the downlink HARQ RTT timer.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with various aspects of the present disclosure. Example process 700 is an example where the UE (e.g., UE 120 and/or the like) performs operations associated with DRX operation in an NTN.

As shown in FIG. 7, in some aspects, process 700 may include starting a timer associated with monitoring for a retransmission of a downlink communication in a network (block 710). For example, the UE (e.g., using communication manager 140, receive processor 258, transmit processor 264, controller/processor 280, memory 282, and/or the like) may start a timer associated with monitoring for a retransmission of a downlink communication in a network, as described above. In some aspects, HARQ feedback is disabled at the UE.

As further shown in FIG. 7, in some aspects, process 700 may include monitoring for the retransmission of the downlink communication after starting the timer or after expiration of the timer (block 720). For example, the user equipment (UE) (e.g., using receive processor 258, transmit processor 264, controller/processor 280, memory 282, and/or the like) may monitor for the retransmission of the downlink communication after starting the timer or after expiration of the timer, as described above. In some aspects, whether the monitoring is after the starting of the timer or after expiration of the timer may depend on a type of the timer (e.g., whether the timer is a downlink HARQ RTT timer or a downlink DRX retransmission timer).

Process 700 may include additional aspects, such as any single aspect or any combination of aspects described below and/or in connection with one or more other processes described elsewhere herein.

In a first aspect, the network is a non-terrestrial network.

In a second aspect, alone or in combination with the first aspect, the timer is a downlink HARQ round trip time (RTT) timer, and the downlink HARQ RTT timer is started at an end of a transmission of the downlink communication. In some aspects, a value of the downlink HARQ RTT timer can be set to zero.

In a third aspect, alone or in combination with one or more of the first and second aspects, the downlink HARQ RTT timer is to be started at the end of an initial transmission only.

In a fourth aspect, alone or in combination with one or more of the first through third aspects, the downlink HARQ RTT timer is to be started at the end of an initial transmission of the downlink communication and at an end of each of a plurality of retransmissions of the downlink communication.

In a fifth aspect, alone or in combination with one or more of the first through fourth aspects, a downlink DRX retransmission timer is started upon expiration of the downlink HARQ RTT timer, and the retransmission of the downlink communication is monitored from a time of starting the downlink DRX retransmission timer to a time of expiration of the downlink DRX retransmission timer.

In a sixth aspect, alone or in combination with one or more of the first through fifth aspects, the downlink DRX retransmission timer is to be started after an initial transmission only, and a plurality of retransmissions of the downlink communication is to occur before expiration of the downlink DRX retransmission timer.

In a seventh aspect, alone or in combination with one or more of the first through sixth aspects, the downlink DRX retransmission timer is to be started after an initial transmission of the downlink communication and after each of a plurality of retransmissions of the downlink communication.

In an eighth aspect, alone or in combination with one or more of the first through seventh aspects, the timer is a downlink DRX retransmission timer, the downlink DRX retransmission timer is started at or after an end of a transmission of the downlink communication, and one or more retransmissions of the downlink communication are monitored from a time of starting the downlink DRX retransmission timer to a time of expiration of the downlink DRX retransmission timer.

In a ninth aspect, alone or in combination with one or more of the first through eighth aspects, the downlink DRX retransmission timer is to be started at or after the end of an initial transmission only.

In a tenth aspect, alone or in combination with one or more of the first through ninth aspects, the downlink DRX retransmission timer is to be started at or after the end of an initial transmission of the downlink communication and at or after an end of each of a plurality of retransmissions of the downlink communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., a terrestrial base station 110, a non-terrestrial base station 110, and/or the like) performs operations associated with DRX operation in an NTN.

As shown in FIG. 8, in some aspects, process 800 may include determining an offset associated with a propagation delay in a network (block 810). For example, the base station (e.g., using communication manager 150, transmit processor 220, receive processor 238, controller/processor 240, memory 242, and/or the like) may determine an offset associated with a propagation delay in a network, as described above. In some aspects, HARQ feedback is enabled at a UE (e.g., UE 120).

As further shown in FIG. 8, in some aspects, process 800 may include scheduling a retransmission of a downlink communication to the UE based at least in part on the offset (block 820). For example, the base station (e.g., using communication manager 150, transmit processor 220, receive processor 238, controller/processor 240, memory 242, and/or the like) may schedule a retransmission of a downlink communication to the UE based at least in part on the offset, as described above.

As further shown in FIG. 8, in some aspects, process 800 may include transmitting the retransmission of the downlink communication based at least in part on scheduling the retransmission of the downlink communication (block 830). For example, the base station (e.g., using communication manager 150, transmit processor 220, receive processor 238, controller/processor 240, memory 242, and/or the like) may transmit the retransmission of the downlink communication based at least in part on scheduling the retransmission of the downlink communication, as described above.

Process 800 may include additional aspects, such as any single aspect or any combination of aspects described below and/or in connection with one or more other processes described elsewhere herein.

In a first aspect, the network is a non-terrestrial network.

In a second aspect, alone or in combination with the first aspect, the offset is determined based at least in part on a result of doubling an estimated one-way propagation delay associated with the network.

In a third aspect, alone or in combination with one or more of the first and second aspects, scheduling the retransmission of the downlink communication is further based at least in part on a configured discontinuous reception state of the UE.

In a fourth aspect, alone or in combination with one or more of the first through third aspects, the retransmission of the downlink communication is transmitted after expiration of a downlink HARQ round trip time timer.

In a fifth aspect, alone or in combination with one or more of the first through fourth aspects, the base station is a terrestrial base station and the retransmission of the downlink communication is to be relayed to the UE by a non-terrestrial base station.

In a sixth aspect, alone or in combination with one or more of the first through fifth aspects, the base station is a non-terrestrial base station.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with various aspects of the present disclosure. Example process 900 is an example where the base station (e.g., a terrestrial base station 110, a non-terrestrial base station 110, and/or the like) performs operations associated with DRX operation in an NTN.

As shown in FIG. 9, in some aspects, process 900 may include starting a timer associated with transmitting a retransmission of a downlink communication to a UE in a network (block 910). For example, the base station (e.g., using communication manager 150, transmit processor 220, receive processor 238, controller/processor 240, memory 242, and/or the like) may start a timer associated with transmitting a retransmission of a downlink communication to a UE (e.g., UE 120) in a network, as described above. In some aspects, HARQ feedback is disabled at the UE.

As further shown in FIG. 9, in some aspects, process 900 may include transmitting the retransmission of the downlink communication after starting the timer or after expiration of the timer (block 920). For example, the base station (e.g., using communication manager 150, transmit processor 220, receive processor 238, controller/processor 240, memory 242, and/or the like) may transmit the retransmission of the downlink communication after starting the timer or after expiration of the timer, as described above. In some aspects, whether the monitoring is after the starting of the timer or after expiration of the timer may depend on a type of the timer (e.g., whether the timer is a downlink HARQ RTT timer or a downlink DRX retransmission timer).

Process 900 may include additional aspects, such as any single aspect or any combination of aspects described below and/or in connection with one or more other processes described elsewhere herein.

In a first aspect, the network is a non-terrestrial network.

In a second aspect, alone or in combination with the first aspect, the timer is a downlink HARQ RTT timer, and the downlink HARQ RTT timer is started at an end of a transmission of the downlink communication. In some aspects, a value of the downlink HARQ RTT timer can be set to zero.

In a third aspect, alone or in combination with one or more of the first and second aspects, the downlink HARQ RTT timer is to be started at the end of the initial transmission only.

In a fourth aspect, alone or in combination with one or more of the first through third aspects, the downlink HARQ RTT timer is to be started at the end of an initial transmission of the downlink communication and at an end of each of a plurality of retransmissions of the downlink communication.

In a fifth aspect, alone or in combination with one or more of the first through fourth aspects, a downlink DRX retransmission timer is started upon expiration of the downlink HARQ RTT timer, and the retransmission of the downlink communication is transmitted during a time window from a time of starting the downlink DRX retransmission timer to a time of expiration of the downlink DRX retransmission timer.

In a sixth aspect, alone or in combination with one or more of the first through fifth aspects, the downlink DRX retransmission timer is to be started after an initial transmission only, and a plurality of retransmissions of the downlink communication is to occur before expiration of the downlink DRX retransmission timer.

In a seventh aspect, alone or in combination with one or more of the first through sixth aspects, the downlink DRX retransmission timer is to be started after an initial transmission of the downlink communication and after each of a plurality of retransmissions of the downlink communication.

In an eighth aspect, alone or in combination with one or more of the first through seventh aspects, the timer is a downlink DRX retransmission timer, the downlink DRX retransmission timer is started at or after an end of a transmission of the downlink communication, and one or more retransmissions of the downlink communication are transmitted in a time window from a time of starting the downlink DRX retransmission timer to a time of expiration of the downlink DRX retransmission timer.

In a ninth aspect, alone or in combination with one or more of the first through eighth aspects, the downlink DRX retransmission timer is to be started at or after the end of an initial transmission only.

In a tenth aspect, alone or in combination with one or more of the first through ninth aspects, the downlink DRX retransmission timer is to be started at or after the end of an initial transmission of the downlink communication and at or after an end of each of a plurality of retransmissions of the downlink communication.

In an eleventh aspect, alone or in combination with one or more of the first through tenth aspects, the base station is a terrestrial base station and the retransmission of the downlink communication is to be relayed to the UE by a non-terrestrial base station.

In a twelfth aspect, alone or in combination with one or more of the first through eleventh aspects, the base station is a non-terrestrial base station.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

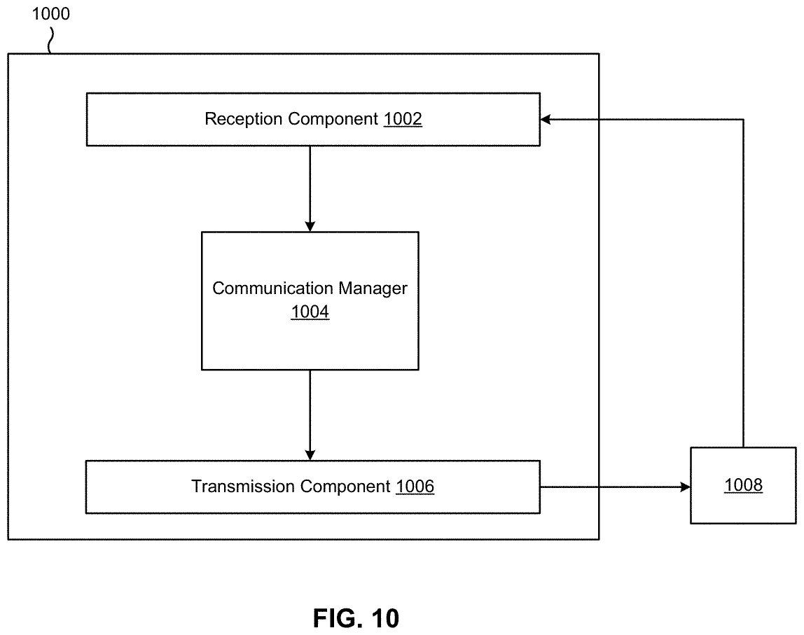

FIG. 10 is a block diagram of an example apparatus 1000 for wireless communication in accordance with various aspects of the present disclosure. The apparatus 1000 may be, be similar to, include, or be included in a UE (e.g., the UE in FIGS. 4A-4E and/or the UE in FIGS. 5A-5E). In some aspects, the apparatus 1000 includes a reception component 1002, a communication manager 1004, and a transmission component 1006, which may be in communication with one another (for example, via one or more buses). As shown, the apparatus 1000 may communicate with another apparatus 1008 (such as a client, a server, a UE, a base station, or another wireless communication device) using the reception component 1002 and the transmission component 1006.

In some aspects, the apparatus 1000 may be configured to perform one or more operations described herein in connection with FIGS. 4A-4E. Additionally, or alternatively, the apparatus 1000 may be configured to perform one or more processes described herein, such as process 600 of FIG. 6. In some aspects, the apparatus 1000 may be configured to perform one or more operations described herein in connection with FIGS. 5A-5E. Additionally, or alternatively, the apparatus 1000 may be configured to perform one or more processes described herein, such as process 700 of FIG. 7. In some aspects, the apparatus 1000 may include one or more components of the first UE described above in connection with FIG. 2.

The reception component 1002 may provide means for receiving communications, such as reference signals, control information, data communications, or a combination thereof, from the apparatus 1008. The reception component 1002 may provide received communications to one or more other components of the apparatus 1000, such as the communication manager 1004. In some aspects, the reception component 1002 may provide means for signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a demodulator, a MIMO detector, a receive processor, a controller/processor, a memory, or a combination thereof, of the first UE described above in connection with FIG. 2.

The transmission component 1006 may provide means for transmitting communications, such as reference signals, control information, data communications, or a combination thereof, to the apparatus 1008. In some aspects, the communication manager 1004 may generate communications and may transmit the generated communications to the transmission component 1006 for transmission to the apparatus 1008. In some aspects, the transmission component 1006 may provide means for performing signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1006 may include one or more antennas, a modulator, a transmit MIMO processor, a transmit processor, a controller/processor, a memory, or a combination thereof, of the first UE described above in connection with FIG. 2. In some aspects, the transmission component 1006 may be co-located with the reception component 1002 in a transceiver.

In some aspects, the communication manager 1004 may provide means for determining an offset associated with a propagation delay in a network, wherein HARQ feedback is enabled at the UE; and means for monitoring for a retransmission of a downlink communication in the network according to the offset. In some aspects, the communication manager 1004 may include a controller/processor, a memory, or a combination thereof, of the UE described above in connection with FIG. 2.

In some aspects, the communication manager 1004 may provide means for starting a timer associated with monitoring for a retransmission of a downlink communication in a network, wherein HARQ feedback is disabled at the UE; and means for monitoring for the retransmission of the downlink communication after starting the timer or after expiration of the timer. In some aspects, the communication manager 1004 may include a controller/processor, a memory, or a combination thereof, of the UE described above in connection with FIG. 2.

In some aspects, the communication manager 1004 may include the reception component 1002, the transmission component 1006, and/or the like. In some aspects, the means provided by the communication manager 1004 may include, or be included within, means provided by the reception component 1002, the transmission component 1006, and/or the like.

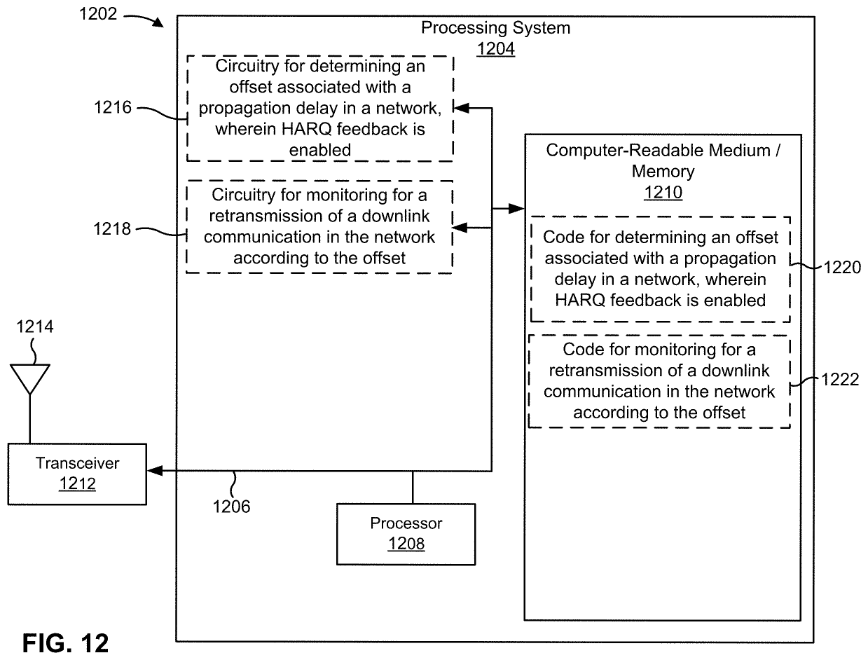

In some aspects, the communication manager 1004 and/or one or more components of the communication manager 1004 may include or may be implemented within hardware (e.g., one or more of the circuitry described in connection with FIG. 12). In some aspects, the communication manager 1004 and/or one or more components thereof may include or may be implemented within a controller/processor, a memory, or a combination thereof, of the UE 120 described above in connection with FIG. 2.

In some aspects, the communication manager 1004 and/or one or more components of the communication manager 1004 may be implemented in code (e.g., as software or firmware stored in a memory), such as the code described in connection with FIGS. 12 and/or 13. For example, the communication manager 1004 and/or a component (or a portion of a component) of the communication manager 1004 may be implemented as instructions or code stored in a non-transitory computer-readable medium and executable by a controller or a processor to perform the functions or operations of the communication manager 1004 and/or the component. If implemented in code, the functions of the communication manager 1004 and/or a component may be executed by a controller/processor, a memory, a scheduler, a communication unit, or a combination thereof, of the UE 120 described above in connection with FIG. 2.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

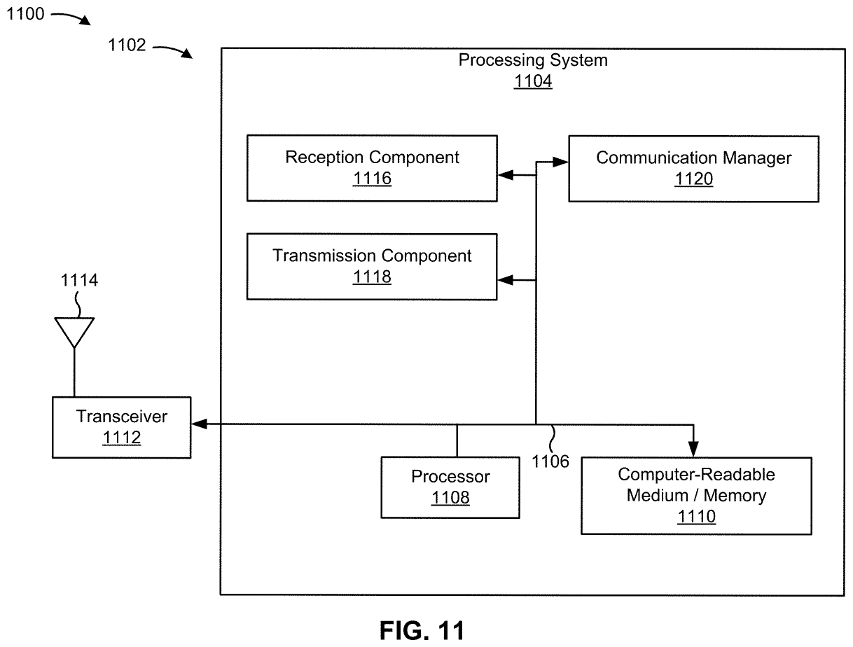

FIG. 11 is a diagram illustrating an example 1100 of a hardware implementation for an apparatus 1102 employing a processing system 1104. The apparatus 1102 may be, be similar to, include, or be included in the apparatus 1000 shown in FIG. 10.

The processing system 1104 may be implemented with a bus architecture, represented generally by the bus 1106. The bus 1106 may include any number of interconnecting buses and bridges depending on the specific application of the processing system 1104 and the overall design constraints. The bus 1106 links together various circuits including one or more processors and/or hardware components, represented by a processor 1108, the illustrated components, and the computer-readable medium/memory 1110. The bus 1106 may also link various other circuits, such as timing sources, peripherals, voltage regulators, power management circuits, and/or the like.

The processing system 1104 may be coupled to a transceiver 1112. The transceiver 1112 is coupled to one or more antennas 1114. The transceiver 1112 provides a means for communicating with various other apparatuses over a transmission medium. The transceiver 1112 receives a signal from the one or more antennas 1114, extracts information from the received signal, and provides the extracted information to the processing system 1104, specifically a reception component 1116. In addition, the transceiver 1112 receives information from the processing system 1104, specifically a transmission component 1118, and generates a signal to be applied to the one or more antennas 1114 based at least in part on the received information. The communication manager 1120 may be component for determining an offset associated with a propagation delay in a network, wherein HARQ feedback is enabled at the UE and for monitoring for a retransmission of a downlink communication in the network according to the offset. Additionally, or alternatively, the communication manager 1120 may be a component for starting a timer associated with monitoring for a retransmission of a downlink communication in a network, wherein HARQ feedback is disabled at the UE, and for monitoring for the retransmission of the downlink communication after starting the timer or after expiration of the timer.

The processor 1108 is coupled to the computer-readable medium/memory 1110. The processor 1108 is responsible for general processing, including the execution of software stored on the computer-readable medium/memory 1110. The software, when executed by the processor 1108, causes the processing system 1104 to perform the various functions described herein in connection with a client. The computer-readable medium/memory 1110 may also be used for storing data that is manipulated by the processor 1108 when executing software. The processing system 1104 may include any number of additional components not illustrated in FIG. 11. The components illustrated and/or not illustrated may be software modules running in the processor 1108, resident/stored in the computer readable medium/memory 1110, one or more hardware modules coupled to the processor 1108, or some combination thereof.

In some aspects, the processing system 1104 may be a component of the UE 120 and may include the memory 282 and/or at least one of the TX MIMO processor 266, the RX processor 258, and/or the controller/processor 280. In some aspects, the apparatus 1102 for wireless communication provides means for determining an offset associated with a propagation delay in a network, wherein HARQ feedback is enabled at the UE; and means for monitoring for a retransmission of a downlink communication in the network according to the offset.

In some aspects, the processing system 1104 may be a component of the UE 120 and may include the memory 282 and/or at least one of the TX MIMO processor 266, the RX processor 258, and/or the controller/processor 280. In some aspects, the apparatus 1102 for wireless communication provides means for starting a timer associated with monitoring for a retransmission of a downlink communication in a network, wherein HARQ feedback is disabled at the UE; and means for monitoring for the retransmission of the downlink communication after starting the timer or after expiration of the timer.

The aforementioned means may be one or more of the aforementioned components of the processing system 1104 of the apparatus 1102 configured to perform the functions recited by the aforementioned means. As described elsewhere herein, the processing system 1104 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

FIG. 12 is a diagram illustrating an example 1200 of an implementation of code and circuitry for an apparatus 1202 for wireless communication. The apparatus 1202 may be, be similar to, include, or be included in the apparatus 1102 shown in FIG. 11 and/or the apparatus 1000 shown in FIG. 10. The apparatus 1202 may include a processing system 1204, which may include a bus 1206 coupling one or more components such as, for example, a processor 1208, computer-readable medium/memory 1210, a transceiver 1212, and/or the like. As shown, the transceiver 1212 may be coupled to one or more antennas 1214.

As further shown in FIG. 12, the apparatus 1202 may include circuitry for determining an offset associated with a propagation delay in a network, wherein HARQ feedback is enabled at the apparatus 1202 (circuitry 1216). For example, the apparatus 1202 may include circuitry 1216 to enable the apparatus 1202 to determine an offset associated with a propagation delay in a network, wherein HARQ feedback is enabled at the apparatus 1202.

As further shown in FIG. 12, the apparatus 1202 may include circuitry for monitoring for a retransmission of a downlink communication in the network according to the offset (circuitry 1218). For example, the apparatus 1202 may include circuitry 1218 to enable the apparatus 1202 to monitor for a retransmission of a downlink communication in the network according to the offset.

As further shown in FIG. 12, the apparatus 1202 may include, stored in computer-readable medium 1210, code for determining an offset associated with a propagation delay in a network, wherein HARQ feedback is enabled at the apparatus 1202 (code 1220). For example, the apparatus 1202 may include code 1220 that, when executed by the processor 1208, may cause the transceiver 1212 to determine an offset associated with a propagation delay in a network, wherein HARQ feedback is enabled at the apparatus 1202.

As further shown in FIG. 12, the apparatus 1202 may include, stored in computer-readable medium 1210, code for monitoring for a retransmission of a downlink communication in the network according to the offset (code 1222). For example, the apparatus 1202 may include code 1222 that, when executed by the processor 1208, may cause the transceiver 1212 to monitor for a retransmission of a downlink communication in the network according to the offset.

FIG. 12 is provided as an example. Other examples may differ from what is described in connection with FIG. 12.

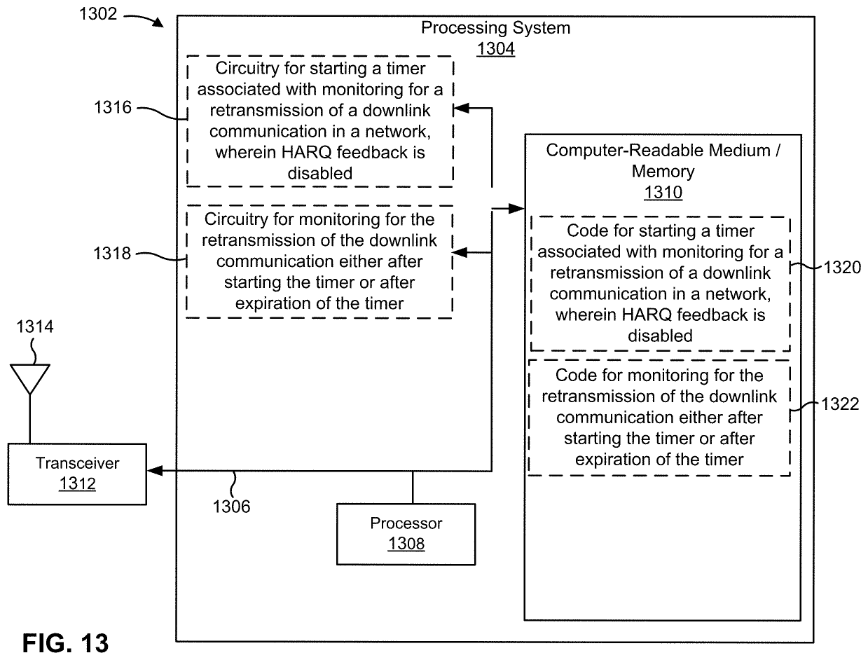

FIG. 13 is a diagram illustrating an example 1300 of an implementation of code and circuitry for an apparatus 1302 for wireless communication. The apparatus 1302 may be, be similar to, include, or be included in the apparatus 1102 shown in FIG. 11 and/or the apparatus 1000 shown in FIG. 10. The apparatus 1302 may include a processing system 1304, which may include a bus 1306 coupling one or more components such as, for example, a processor 1308, computer-readable medium/memory 1310, a transceiver 1312, and/or the like. As shown, the transceiver 1312 may be coupled to one or more antennas 1314.

As further shown in FIG. 13, the apparatus 1302 may include circuitry for starting a timer associated with monitoring for a retransmission of a downlink communication in a network, wherein HARQ feedback is disabled at the apparatus 1302 (circuitry 1316). For example, the apparatus 1302 may include circuitry 1316 to enable the apparatus 1302 to start a timer associated with monitoring for a retransmission of a downlink communication in a network, wherein HARQ feedback is disabled at the apparatus 1302.

As further shown in FIG. 13, the apparatus 1302 may include circuitry for monitoring for the retransmission of the downlink communication after starting the timer or after expiration of the timer (circuitry 1318). For example, the apparatus 1302 may include circuitry 1318 to enable the apparatus 1302 to monitor for the retransmission of the downlink communication after starting the timer or after expiration of the timer.

As further shown in FIG. 13, the apparatus 1302 may include, stored in computer-readable medium 1310, code for starting a timer associated with monitoring for a retransmission of a downlink communication in a network, wherein HARQ feedback is disabled at the apparatus 1302 (code 1320). For example, the apparatus 1302 may include code 1320 that, when executed by the processor 1308, may cause the transceiver 1312 to start a timer associated with monitoring for a retransmission of a downlink communication in a network, wherein HARQ feedback is disabled at the apparatus 1302.

As further shown in FIG. 13, the apparatus 1302 may include, stored in computer-readable medium 1310, code for monitoring for the retransmission of the downlink communication after starting the timer or after expiration of the timer (code 1322). For example, the apparatus 1302 may include code 1322 that, when executed by the processor 1308, may cause the transceiver 1312 to monitor for the retransmission of the downlink communication after starting the timer or after expiration of the timer.

FIG. 13 is provided as an example. Other examples may differ from what is described in connection with FIG. 13.

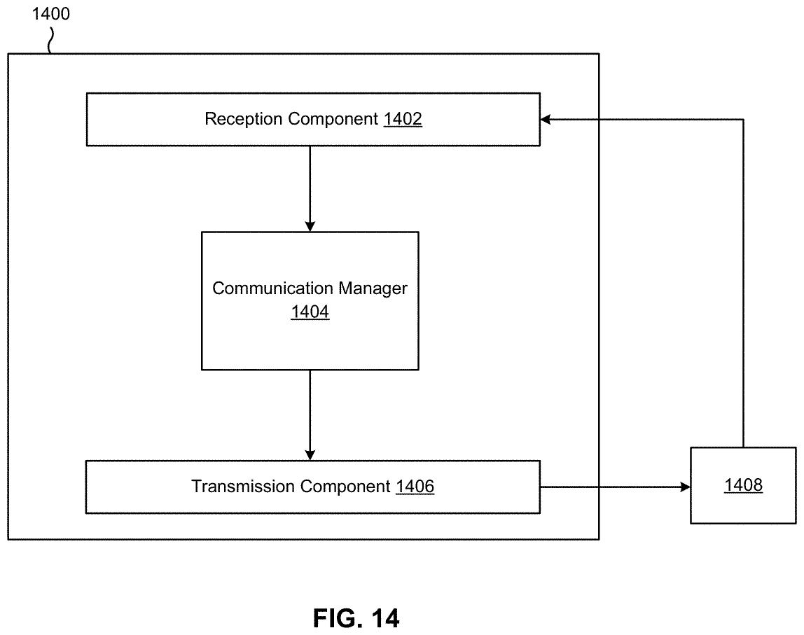

FIG. 14 is a block diagram of an example apparatus 1400 for wireless communication in accordance with various aspects of the present disclosure. The apparatus 1400 may be, be similar to, include, or be included in a base station (e.g., the base station in FIGS. 4A-4E and/or the UE in FIGS. 5A-5E). In some aspects, the apparatus 1400 includes a reception component 1402, a communication manager 1404, and a transmission component 1406, which may be in communication with one another (for example, via one or more buses). As shown, the apparatus 1400 may communicate with another apparatus 1408 (such as a client, a server, a UE, a base station, or another wireless communication device) using the reception component 1402 and the transmission component 1406.

In some aspects, the apparatus 1400 may be configured to perform one or more operations described herein in connection with FIGS. 4A-4E. Additionally, or alternatively, the apparatus 1400 may be configured to perform one or more processes described herein, such as process 800 of FIG. 8. In some aspects, the apparatus 1400 may be configured to perform one or more operations described herein in connection with FIGS. 5A-5E. Additionally, or alternatively, the apparatus 1400 may be configured to perform one or more processes described herein, such as process 900 of FIG. 9. In some aspects, the apparatus 1400 may include one or more components of the first UE described above in connection with FIG. 2.

The reception component 1402 may provide means for receiving communications, such as reference signals, control information, data communications, or a combination thereof, from the apparatus 1408. The reception component 1402 may provide received communications to one or more other components of the apparatus 1400, such as the communication manager 1404. In some aspects, the reception component 1402 may provide means for signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a demodulator, a MIMO detector, a receive processor, a controller/processor, a memory, or a combination thereof, of the first UE described above in connection with FIG. 2.

The transmission component 1406 may provide means for transmitting communications, such as reference signals, control information, data communications, or a combination thereof, to the apparatus 1408. In some aspects, the communication manager 1404 may generate communications and may transmit the generated communications to the transmission component 1406 for transmission to the apparatus 1408. In some aspects, the transmission component 1406 may provide means for performing signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1406 may include one or more antennas, a modulator, a transmit MIMO processor, a transmit processor, a controller/processor, a memory, or a combination thereof, of the first UE described above in connection with FIG. 2. In some aspects, the transmission component 1406 may be co-located with the reception component 1402 in a transceiver.

In some aspects, the communication manager 1404 may provide means for determining an offset associated with a propagation delay in a network, wherein HARQ feedback is enabled at a UE; means for scheduling a retransmission of a downlink communication to the UE based at least in part on the offset; and means for transmitting the retransmission of the downlink communication based at least in part on scheduling the retransmission of the downlink communication. In some aspects, the communication manager 1404 may include a controller/processor, a memory, or a combination thereof, of the UE described above in connection with FIG. 2.

In some aspects, the communication manager 1404 may provide means for starting a timer associated with transmitting a retransmission of a downlink communication to a UE in a network, wherein HARQ feedback is disabled at the UE; and means for transmitting the retransmission of the downlink communication after starting the timer or after expiration of the timer. In some aspects, the communication manager 1404 may include a controller/processor, a memory, or a combination thereof, of the UE described above in connection with FIG. 2.

In some aspects, the communication manager 1404 may include the reception component 1402, the transmission component 1406, and/or the like. In some aspects, the means provided by the communication manager 1404 may include, or be included within, means provided by the reception component 1402, the transmission component 1406, and/or the like.

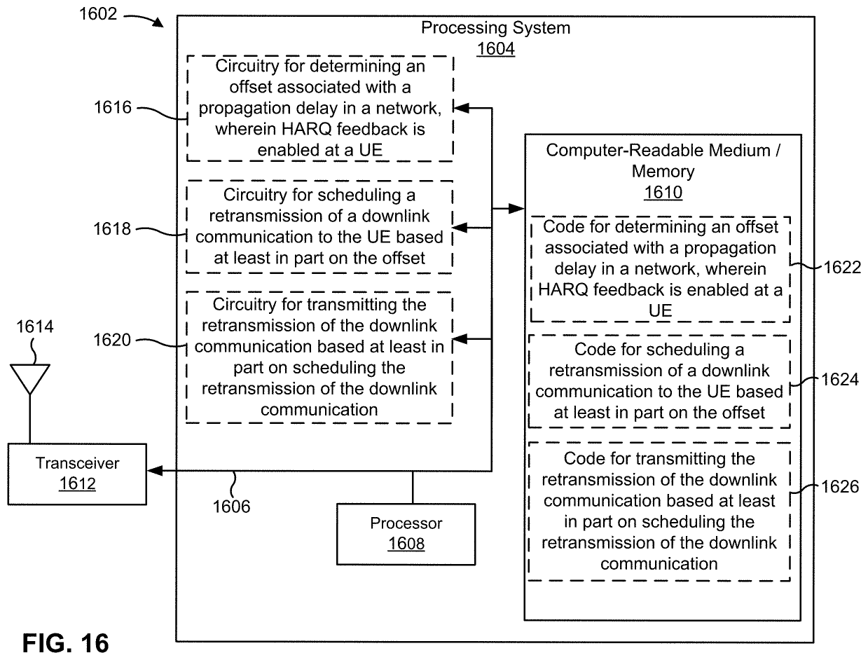

In some aspects, the communication manager 1404 and/or one or more components of the communication manager 1404 may include or may be implemented within hardware (e.g., one or more of the circuitry described in connection with FIGS. 16 and/or 17). In some aspects, the communication manager 1404 and/or one or more components thereof may include or may be implemented within a controller/processor, a memory, or a combination thereof, of the UE 120 described above in connection with FIG. 2.

In some aspects, the communication manager 1404 and/or one or more components of the communication manager 1404 may be implemented in code (e.g., as software or firmware stored in a memory), such as the code described in connection with FIGS. 16 and/or 17. For example, the communication manager 1404 and/or a component (or a portion of a component) of the communication manager 1404 may be implemented as instructions or code stored in a non-transitory computer-readable medium and executable by a controller or a processor to perform the functions or operations of the communication manager 1404 and/or the component. If implemented in code, the functions of the communication manager 1404 and/or a component may be executed by a controller/processor, a memory, a scheduler, a communication unit, or a combination thereof, of the UE 120 described above in connection with FIG. 2.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

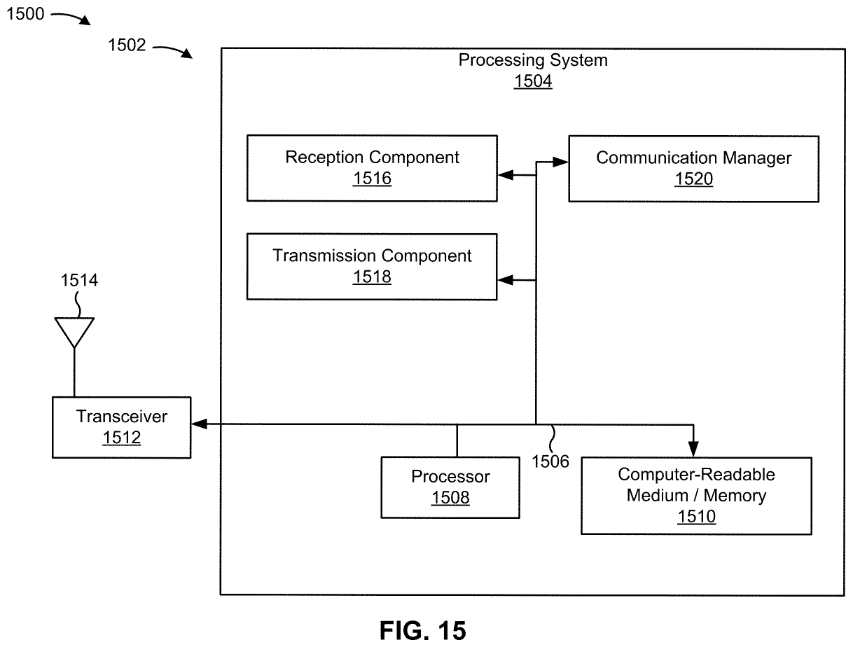

FIG. 15 is a diagram illustrating an example 1500 of a hardware implementation for an apparatus 1502 employing a processing system 1504. The apparatus 1502 may be, be similar to, include, or be included in the apparatus 1400 shown in FIG. 14.

The processing system 1504 may be implemented with a bus architecture, represented generally by the bus 1506. The bus 1506 may include any number of interconnecting buses and bridges depending on the specific application of the processing system 1504 and the overall design constraints. The bus 1506 links together various circuits including one or more processors and/or hardware components, represented by a processor 1508, the illustrated components, and the computer-readable medium/memory 1510. The bus 1506 may also link various other circuits, such as timing sources, peripherals, voltage regulators, power management circuits, and/or the like.

The processing system 1504 may be coupled to a transceiver 1512. The transceiver 1512 is coupled to one or more antennas 1514. The transceiver 1512 provides a means for communicating with various other apparatuses over a transmission medium. The transceiver 1512 receives a signal from the one or more antennas 1514, extracts information from the received signal, and provides the extracted information to the processing system 1504, specifically a reception component 1516. In addition, the transceiver 1512 receives information from the processing system 1504, specifically a transmission component 1518, and generates a signal to be applied to the one or more antennas 1514 based at least in part on the received information. The communication manager 1520 may be a component for determining an offset associated with a propagation delay in a network, wherein HARQ feedback is enabled at a UE, scheduling a retransmission of a downlink communication to the UE based at least in part on the offset, and transmitting the retransmission of the downlink communication based at least in part on scheduling the retransmission of the downlink communication. Additionally, or alternatively, the communication manager 1520 may be a component for starting a timer associated with transmitting a retransmission of a downlink communication to a UE in a network, wherein HARQ feedback is disabled at the UE, and transmitting the retransmission of the downlink communication after starting the timer or after expiration of the timer.

The processor 1508 is coupled to the computer-readable medium/memory 1510. The processor 1508 is responsible for general processing, including the execution of software stored on the computer-readable medium/memory 1510. The software, when executed by the processor 1508, causes the processing system 1504 to perform the various functions described herein in connection with a client. The computer-readable medium/memory 1510 may also be used for storing data that is manipulated by the processor 1508 when executing software. The processing system 1504 may include any number of additional components not illustrated in FIG. 15. The components illustrated and/or not illustrated may be software modules running in the processor 1508, resident/stored in the computer readable medium/memory 1510, one or more hardware modules coupled to the processor 1508, or some combination thereof.

In some aspects, the processing system 1504 may be a component of the UE 120 and may include the memory 282 and/or at least one of the TX MIMO processor 266, the RX processor 258, and/or the controller/processor 280. In some aspects, the apparatus 1502 for wireless communication provides means for determining an offset associated with a propagation delay in a network, wherein HARQ feedback is enabled at a UE; means for scheduling a retransmission of a downlink communication to the UE based at least in part on the offset; and means for transmitting the retransmission of the downlink communication based at least in part on scheduling the retransmission of the downlink communication. The aforementioned means may be one or more of the aforementioned components of the processing system 1504 of the apparatus 1502 configured to perform the functions recited by the aforementioned means.

In some aspects, the processing system 1504 may be a component of the UE 120 and may include the memory 282 and/or at least one of the TX MIMO processor 266, the RX processor 258, and/or the controller/processor 280. In some aspects, the apparatus 1502 for wireless communication provides means for starting a timer associated with transmitting a retransmission of a downlink communication to a UE in a network, wherein HARQ feedback is disabled at the UE; and means for transmitting the retransmission of the downlink communication after starting the timer or after expiration of the timer. The aforementioned means may be one or more of the aforementioned components of the processing system 1504 of the apparatus 1502 configured to perform the functions recited by the aforementioned means.

As described elsewhere herein, the processing system 1504 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 15 is provided as an example. Other examples may differ from what is described in connection with FIG. 15.

FIG. 16 is a diagram illustrating an example 1600 of an implementation of code and circuitry for an apparatus 1602 for wireless communication. The apparatus 1602 may be, be similar to, include, or be included in the apparatus 1502 shown in FIG. 15 and/or the apparatus 1400 shown in FIG. 14. The apparatus 1602 may include a processing system 1604, which may include a bus 1606 coupling one or more components such as, for example, a processor 1608, computer-readable medium/memory 1610, a transceiver 1612, and/or the like. As shown, the transceiver 1612 may be coupled to one or more antennas 1614.

As further shown in FIG. 16, the apparatus 1602 may include circuitry for determining an offset associated with a propagation delay in a network, wherein HARQ feedback is enabled at a UE (circuitry 1616). For example, the apparatus 1602 may include circuitry 1616 to enable the apparatus 1602 to determine an offset associated with a propagation delay in a network, wherein HARQ feedback is enabled at a UE.

As further shown in FIG. 16, the apparatus 1602 may include circuitry for scheduling a retransmission of a downlink communication to the UE based at least in part on the offset (circuitry 1618). For example, the apparatus 1602 may include circuitry 1618 to enable the apparatus 1602 to schedule a retransmission of a downlink communication to the UE based at least in part on the offset.

As further shown in FIG. 16, the apparatus 1602 may include circuitry for transmitting the retransmission of the downlink communication based at least in part on scheduling the retransmission of the downlink communication (circuitry 1620). For example, the apparatus 1602 may include circuitry 1618 to enable the apparatus 1602 to transmit the retransmission of the downlink communication based at least in part on scheduling the retransmission of the downlink communication.

As further shown in FIG. 16, the apparatus 1602 may include, stored in computer-readable medium 1610, code for determining an offset associated with a propagation delay in a network, wherein HARQ feedback is enabled at a UE. (code 1622). For example, the apparatus 1602 may include code 1622 that, when executed by the processor 1608, may cause the transceiver 1612 to determine an offset associated with a propagation delay in a network, wherein HARQ feedback is enabled at a UE.

As further shown in FIG. 16, the apparatus 1602 may include, stored in computer-readable medium 1610, code for scheduling a retransmission of a downlink communication to the UE based at least in part on the offset (code 1624). For example, the apparatus 1602 may include code 1624 that, when executed by the processor 1608, may cause the transceiver 1612 to schedule a retransmission of a downlink communication to the UE based at least in part on the offset.

As further shown in FIG. 16, the apparatus 1602 may include, stored in computer-readable medium 1610, code for transmitting the retransmission of the downlink communication based at least in part on scheduling the retransmission of the downlink communication (code 1626). For example, the apparatus 1602 may include code 1626 that, when executed by the processor 1608, may cause the transceiver 1612 to transmit the retransmission of the downlink communication based at least in part on scheduling the retransmission of the downlink communication.

FIG. 16 is provided as an example. Other examples may differ from what is described in connection with FIG. 16.

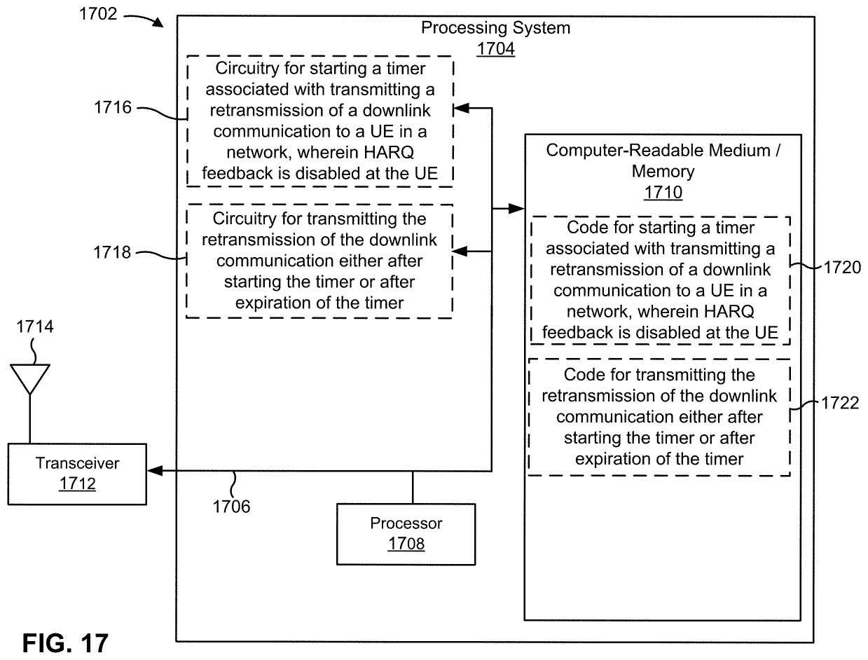

FIG. 17 is a diagram illustrating an example 1700 of an implementation of code and circuitry for an apparatus 1702 for wireless communication. The apparatus 1702 may be, be similar to, include, or be included in the apparatus 1502 shown in FIG. 15 and/or the apparatus 1400 shown in FIG. 14. The apparatus 1702 may include a processing system 1704, which may include a bus 1706 coupling one or more components such as, for example, a processor 1708, computer-readable medium/memory 1710, a transceiver 1712, and/or the like. As shown, the transceiver 1712 may be coupled to one or more antennas 1714.

As further shown in FIG. 17, the apparatus 1702 may include circuitry for starting a timer associated with transmitting a retransmission of a downlink communication to a UE in a network, wherein HARQ feedback is disabled at the UE (circuitry 1716). For example, the apparatus 1702 may include circuitry 1716 to enable the apparatus 1702 to start a timer associated with transmitting a retransmission of a downlink communication to a UE in a network, wherein HARQ feedback is disabled at the UE.

As further shown in FIG. 17, the apparatus 1702 may include circuitry for transmitting the retransmission of the downlink communication after starting the timer or after expiration of the timer (circuitry 1718). For example, the apparatus 1702 may include circuitry 1718 to enable the apparatus 1702 to transmit the retransmission of the downlink communication after starting the timer or after expiration of the timer.

As further shown in FIG. 17, the apparatus 1702 may include, stored in computer-readable medium 1710, code for starting a timer associated with transmitting a retransmission of a downlink communication to a UE in a network, wherein HARQ feedback is disabled at the UE (code 1720). For example, the apparatus 1702 may include code 1720 that, when executed by the processor 1708, may cause the transceiver 1712 to start a timer associated with transmitting a retransmission of a downlink communication to a UE in a network, wherein HARQ feedback is disabled at the UE.

As further shown in FIG. 17, the apparatus 1702 may include, stored in computer-readable medium 1710, code for transmitting the retransmission of the downlink communication after starting the timer or after expiration of the timer (code 1722). For example, the apparatus 1702 may include code 1722 that, when executed by the processor 1708, may cause the transceiver 1712 to transmit the retransmission of the downlink communication after starting the timer or after expiration of the timer.

FIG. 17 is provided as an example. Other examples may differ from what is described in connection with FIG. 17.

The following provides an overview of aspects of the present disclosure:

Aspect 1: A method of wireless communication performed by a user equipment (UE), comprising: determining an offset associated with a propagation delay in a network, wherein hybrid automatic repeat request (HARQ) feedback is enabled at the UE; and monitoring for a retransmission of a downlink communication in the network according to the offset.

Aspect 2: The method of aspect 1, wherein the network is a non-terrestrial network.

Aspect 3: The method of any of aspects 1-2, further comprising adding the offset to a timer value, a result of adding the offset to the timer value being a downlink HARQ round trip time (RTT) timer value.

Aspect 4: The method of aspect 3, further comprising: starting a downlink HARQ RTT timer based at least in part on the downlink HARQ RTT timer value; and monitoring for the retransmission of the downlink communication after expiration of the downlink HARQ RTT timer.

Aspect 5: The method of aspect 4, wherein the UE is in a configured discontinuous reception cycle operation from a time of the starting of the downlink HARQ RTT timer to a time of the expiration of the downlink HARQ RTT timer.

Aspect 6: The method of aspect 4, wherein the UE is in discontinuous reception ON operation from a time of starting the downlink HARQ RTT timer to a time of the expiration of the downlink HARQ RTT timer.

Aspect 7: The method of any of aspects 1-6, wherein determining the offset comprises doubling an estimated one-way propagation delay associated with the network, a result of doubling an estimated one-way propagation delay being the offset.

Aspect 8: The method of any of aspects 1-7, wherein an offset timer is configured based at least in part on the offset, the offset timer being used to delay a start of a downlink discontinuous reception (DRX) retransmission timer.

Aspect 9: The method of any of aspects 1-8, further comprising: starting a downlink HARQ round trip time (RTT) timer based at least in part on a configured downlink HARQ RTT timer value; starting the offset timer after expiration of the downlink HARQ RTT timer; and monitoring for the retransmission of the downlink communication after expiration of the offset timer.

Aspect 10: The method of aspect 9, wherein the configured downlink HARQ RTT timer value is zero.

Aspect 11: The method of aspect 9, wherein the UE is in a configured discontinuous reception cycle operation from a time of the starting of the offset timer to a time of the expiration of the offset timer.

Aspect 12: The method of aspect 9, wherein the UE is in discontinuous reception sleep operation from a time of the starting of the offset timer to a time of the expiration of the offset timer.

Aspect 13: The method of any of aspects 1-2 and 7, wherein an offset timer is configured based at least in part on the offset, the offset timer being used to delay a start of a HARQ RTT timer.

Aspect 14: A method of wireless communication performed by a user equipment (UE), comprising: starting a timer associated with monitoring for a retransmission of a downlink communication in a network, wherein hybrid automatic repeat request (HARQ) feedback is disabled at the UE; and monitoring for the retransmission of the downlink communication after starting the timer or after expiration of the timer.

Aspect 15: The method of aspect 14, wherein the network is a non-terrestrial network.

Aspect 16: The method of any of aspects 14-15, wherein the timer is a downlink HARQ round trip time (RTT) timer, and wherein the method further comprises starting the downlink HARQ RTT timer at an end of a transmission of the downlink communication.

Aspect 17: The method of aspect 16, wherein a value of the downlink HARQ RTT timer is set to zero.

Aspect 18: The method of aspect 16, wherein the downlink HARQ RTT timer is to be started at the end of an initial transmission only.

Aspect 19: The method of aspect 16, wherein the downlink HARQ RTT timer is to be started at the end of an initial transmission of the downlink communication and at an end of each of a plurality of retransmissions of the downlink communication.

Aspect 20: The method of aspect 16, further comprising starting a downlink discontinuous reception (DRX) retransmission timer upon expiration of the downlink HARQ RTT timer, wherein the method further comprises monitoring one or more retransmissions of the downlink communication from a time of starting the downlink DRX retransmission timer to a time of expiration of the downlink DRX retransmission timer,

Aspect 21: The method of aspect 20, wherein the downlink DRX retransmission timer is to be started at the end of an initial transmission only.

Aspect 22: The method of aspect 20, wherein the downlink DRX retransmission timer is to be started after an initial transmission only, wherein a plurality of retransmissions of the downlink communication is to occur before expiration of the downlink DRX retransmission timer.

Aspect 23: The method of aspect 20, wherein the downlink DRX retransmission timer is to be started after an initial transmission of the downlink communication and after each of a plurality of retransmissions of the downlink communication.

Aspect 24: The method of any of aspects 14-23, wherein the timer is a downlink discontinuous reception (DRX) retransmission timer, wherein the method further comprises starting the downlink DRX retransmission timer at or after an end of a transmission of the downlink communication, and wherein the method further comprises monitoring one or more retransmissions of the downlink communication from a time of starting the downlink DRX retransmission timer to a time of expiration of the downlink DRX retransmission timer.

Aspect 25: The method of aspect 24, wherein the downlink DRX retransmission timer is to be started at or after the end of an initial transmission only.

Aspect 26: The method of aspect 24, wherein the downlink DRX retransmission timer is to be started at or after the end of a transmission of the downlink communication and at or after an end of each of a plurality of retransmissions of the downlink communication.

Aspect 27: A method of wireless communication performed by a base station, comprising: determining an offset associated with a propagation delay in a network, wherein hybrid automatic repeat request (HARQ) feedback is enabled at a user equipment (UE); scheduling a retransmission of a downlink communication to the UE based at least in part on the offset; and transmitting the retransmission of the downlink communication based at least in part on scheduling the retransmission of the downlink communication.

Aspect 28: The method of aspect 27, wherein the network is a non-terrestrial network.

Aspect 29: The method of any of aspects 27-28, wherein determining the offset comprises doubling an estimated one-way propagation delay associated with the network, a result of doubling an estimated one-way propagation delay being the offset.

Aspect 30: The method of any of aspects 27-29, wherein scheduling the retransmission of the downlink communication is further based at least in part on a configured discontinuous reception state of the UE.

Aspect 31: The method of any of aspects 27-30, wherein the retransmission of the downlink communication is transmitted after expiration of a downlink HARQ round trip time timer.

Aspect 32: The method of any of aspects 27-31, wherein the base station is a terrestrial base station and the retransmission of the downlink communication is to be relayed to the UE by a non-terrestrial base station.

Aspect 33: The method of any of aspects 27-31, wherein the base station is a non-terrestrial base station.

Aspect 34: A method of wireless communication performed by a base station, comprising: starting a timer associated with transmitting a retransmission of a downlink communication to a user equipment (UE) in a network, wherein hybrid automatic repeat request (HARQ) feedback is disabled at the UE; and transmitting the retransmission of the downlink communication after starting the timer or after expiration of the timer.

Aspect 35: The method of aspect 34, wherein the network is a non-terrestrial network.

Aspect 36: The method of any of aspects 34-35, wherein the timer is a downlink HARQ round trip time (RTT) timer, and wherein the method further comprises starting the downlink HARQ RTT timer at an end of a transmission of the downlink communication.

Aspect 37: The method of aspect 36, wherein a value of the downlink HARQ RTT timer is set to zero.

Aspect 38: The method of aspect 36, wherein the downlink HARQ RTT timer is to be started at the end of an initial transmission only.

Aspect 39: The method of aspect 36, wherein the downlink HARQ RTT timer is to be started at the end of an initial transmission of the downlink communication and at an end of each of a plurality of retransmissions of the downlink communication.

Aspect 40: The method of aspect 36, wherein the method further comprises starting a downlink discontinuous reception (DRX) retransmission timer upon expiration of the downlink HARQ RTT timer, wherein the retransmission of the downlink communication is transmitted during a time window from a time of starting the downlink DRX retransmission timer to a time of expiration of the downlink DRX retransmission timer.

Aspect 41: The method of aspect 40, wherein the downlink DRX retransmission timer is to be started after an initial transmission only, wherein a plurality of retransmissions of the downlink communication is to occur before expiration of the downlink DRX retransmission timer.

Aspect 42: The method of aspect 40, wherein the downlink DRX retransmission timer is to be started after an initial transmission of the downlink communication and after each of a plurality of retransmissions of the downlink communication.

Aspect 43: The method of any of aspects 34-42, wherein the timer is a downlink discontinuous reception (DRX) retransmission timer, wherein the method further comprises starting the downlink DRX retransmission timer at or after an end of a transmission of the downlink communication, and wherein one or more retransmissions of the downlink communication are transmitted in a time window from a time of starting the downlink DRX retransmission timer to a time of expiration of the downlink DRX retransmission timer.

Aspect 44: The method of aspect 43, wherein the downlink DRX retransmission timer is to be started at or after the end of an initial transmission only.

Aspect 45: The method of aspect 43, wherein the downlink DRX retransmission timer is to be started at or after the end of an initial transmission of the downlink communication and at or after an end of each of a plurality of retransmissions of the downlink communication.

Aspect 46: The method of any of aspects 34-45, wherein the base station is a terrestrial base station and the retransmission of the downlink communication is to be relayed to the UE by a non-terrestrial base station.

Aspect 47: The method of any of aspects 34-45, wherein the base station is a non-terrestrial base station.

Aspect 48: An apparatus for wireless communication at a device, comprising a processor; memory coupled with the processor; and instructions stored in the memory and executable by the processor to cause the apparatus to perform the method of one or more aspects of aspects 1-13.

Aspect 49: A device for wireless communication, comprising a memory and one or more processors coupled to the memory, the memory and the one or more processors configured to perform the method of one or more aspects of aspects 1-13.

Aspect 50: An apparatus for wireless communication, comprising at least one means for performing the method of one or more aspects of aspects 1-13.

Aspect 51: A non-transitory computer-readable medium storing code for wireless communication, the code comprising instructions executable by a processor to perform the method of one or more aspects of aspects 1-13.

Aspect 52: A non-transitory computer-readable medium storing a set of instructions for wireless communication, the set of instructions comprising one or more instructions that, when executed by one or more processors of a device, cause the device to perform the method of one or more aspects of aspects 1-13.

Aspect 53: An apparatus for wireless communication at a device, comprising a processor; memory coupled with the processor; and instructions stored in the memory and executable by the processor to cause the apparatus to perform the method of one or more aspects of aspects 13-26.

Aspect 54: A device for wireless communication, comprising a memory and one or more processors coupled to the memory, the memory and the one or more processors configured to perform the method of one or more aspects of aspects 13-26.

Aspect 55: An apparatus for wireless communication, comprising at least one means for performing the method of one or more aspects of aspects 13-26.

Aspect 56: A non-transitory computer-readable medium storing code for wireless communication, the code comprising instructions executable by a processor to perform the method of one or more aspects of aspects 13-26.

Aspect 57: A non-transitory computer-readable medium storing a set of instructions for wireless communication, the set of instructions comprising one or more instructions that, when executed by one or more processors of a device, cause the device to perform the method of one or more aspects of aspects 13-26.

Aspect 58: An apparatus for wireless communication at a device, comprising a processor; memory coupled with the processor; and instructions stored in the memory and executable by the processor to cause the apparatus to perform the method of one or more aspects of aspects 27-33.

Aspect 59: A device for wireless communication, comprising a memory and one or more processors coupled to the memory, the memory and the one or more processors configured to perform the method of one or more aspects of aspects 27-33.

Aspect 60: An apparatus for wireless communication, comprising at least one means for performing the method of one or more aspects of aspects 27-33.

Aspect 61: A non-transitory computer-readable medium storing code for wireless communication, the code comprising instructions executable by a processor to perform the method of one or more aspects of aspects 27-33.

Aspect 62: A non-transitory computer-readable medium storing a set of instructions for wireless communication, the set of instructions comprising one or more instructions that, when executed by one or more processors of a device, cause the device to perform the method of one or more aspects of aspects 27-33.

Aspect 63: An apparatus for wireless communication at a device, comprising a processor; memory coupled with the processor; and instructions stored in the memory and executable by the processor to cause the apparatus to perform the method of one or more aspects of aspects 34-47.

Aspect 64: A device for wireless communication, comprising a memory and one or more processors coupled to the memory, the memory and the one or more processors configured to perform the method of one or more aspects of aspects 34-47.

Aspect 65: An apparatus for wireless communication, comprising at least one means for performing the method of one or more aspects of aspects 34-47.

Aspect 66: A non-transitory computer-readable medium storing code for wireless communication, the code comprising instructions executable by a processor to perform the method of one or more aspects of aspects 34-47.

Aspect 67: A non-transitory computer-readable medium storing a set of instructions for wireless communication, the set of instructions comprising one or more instructions that, when executed by one or more processors of a device, cause the device to perform the method of one or more aspects of aspects 34-47.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
determining an offset associated with a propagation delay in a network, wherein hybrid automatic repeat request (HARQ) feedback is enabled at the UE; and
monitoring for a retransmission of a downlink communication in the network according to the offset.

2. The method of claim 1, wherein the network is a non-terrestrial network.

3. The method of claim 1, further comprising adding the offset to a timer value, a result of adding the offset to the timer value being a downlink HARQ round trip time (RTT) timer value.

4. The method of claim 3, further comprising:
starting a downlink HARQ RTT timer based at least in part on the downlink HARQ RTT timer value; and
monitoring for the retransmission of the downlink communication after expiration of the downlink HARQ RTT timer.

5. The method of claim 4, wherein the UE operates according to a configured discontinuous reception cycle from a time of the starting of the downlink HARQ RTT timer to a time of the expiration of the downlink HARQ RTT timer.

6. The method of claim 4, wherein the UE is in discontinuous reception ON operation from a time of the starting of the downlink HARQ RTT timer to a time of the expiration of the downlink HARQ RTT timer.

7. The method of claim 1, wherein determining the offset comprises doubling an estimated one-way propagation delay associated with the network, a result of doubling the estimated one-way propagation delay being the offset.

8. The method of claim 1, wherein an offset timer is configured based at least in part on the offset, the offset timer being used to delay a start of a downlink discontinuous reception (DRX) retransmission timer.

9. The method of claim 8, further comprising:
starting a downlink HARQ round trip time (RTT) timer based at least in part on a configured downlink HARQ RTT timer value;
starting the offset timer after expiration of the downlink HARQ RTT timer; and
monitoring for the retransmission of the downlink communication after expiration of the offset timer.

10. The method of claim 9, wherein the configured downlink HARQ RTT timer value is zero.

11. The method of claim 9, wherein the UE is in a configured discontinuous reception cycle operation from a time of the starting of the offset timer to a time of the expiration of the offset timer.

12. The method of claim 9, wherein the UE is in discontinuous reception sleep operation from a time of the starting of the offset timer to a time of the expiration of the offset timer.

13. A method of wireless communication performed by a user equipment (UE), comprising:
starting a timer associated with monitoring for a retransmission of a downlink communication in a network, wherein hybrid automatic repeat request (HARQ) feedback is disabled at the UE; and
monitoring for the retransmission of the downlink communication after starting the timer or after expiration of the timer.

14. The method of claim 13, wherein the network is a non-terrestrial network.

15. The method of claim 13, wherein the timer is a downlink HARQ round trip time (RTT) timer, and the method further comprises starting the downlink HARQ RTT timer at an end of a transmission of the downlink communication.

16. The method of claim 15, wherein a value of the downlink HARQ RTT timer is set to zero.

17. The method of claim 15, wherein the downlink HARQ RTT timer is to be started at the end of an initial transmission only.

18. The method of claim 15, wherein the downlink HARQ RTT timer is to be started at the end of an initial transmission of the downlink communication and at an end of each of a plurality of retransmissions of the downlink communication.

19. The method of claim 15, further comprising starting a downlink discontinuous reception (DRX) retransmission timer upon expiration of the downlink HARQ RTT timer, and monitoring the retransmission of the downlink communication from a time of starting the downlink DRX retransmission timer to a time of expiration of the downlink DRX retransmission timer.

20. The method of claim 13, wherein the timer is a downlink discontinuous reception (DRX) retransmission timer,
wherein the method further comprises starting the downlink DRX retransmission timer at or after an end of a transmission of the downlink communication, and
wherein the method further comprises monitoring one or more retransmissions of the downlink communication from a time of starting the downlink DRX retransmission timer to a time of expiration of the downlink DRX retransmission timer.

21. The method of claim 20, wherein the downlink DRX retransmission timer is to be started at the end of an initial transmission only.

22. A method of wireless communication performed by a base station, comprising:
determining an offset associated with a propagation delay in a network,
wherein hybrid automatic repeat request (HARQ) feedback is enabled at a user equipment (UE);
scheduling a retransmission of a downlink communication to the UE based at least in part on the offset; and
transmitting the retransmission of the downlink communication based at least in part on scheduling the retransmission of the downlink communication.

23. The method of claim 22, wherein the network is a non-terrestrial network.

24. The method of claim 22, wherein determining the offset comprises doubling an estimated one-way propagation delay associated with the network, a result of doubling an estimated one-way propagation delay being the offset.

25. The method of claim 22, wherein scheduling the retransmission of the downlink communication is further based at least in part on a configured discontinuous reception state of the UE.

26. The method of claim 22, wherein the retransmission of the downlink communication is transmitted after expiration of a downlink HARQ round trip time timer.

27. The method of claim 22, wherein the base station is a terrestrial base station and the retransmission of the downlink communication is to be relayed to the UE by a non-terrestrial base station.

28. The method of claim 22, wherein the base station is a non-terrestrial base station.

29. A method of wireless communication performed by a base station, comprising:
starting a timer associated with transmitting a retransmission of a downlink communication to a user equipment (UE) in a network,
wherein hybrid automatic repeat request (HARQ) feedback is disabled at the UE; and
transmitting the retransmission of the downlink communication after starting the timer or after expiration of the timer.

30. The method of claim 29, wherein the timer is a downlink HARQ round trip time (RTT) timer, and
wherein the method further comprises starting the downlink HARQ RTT timer at an end of a transmission of the downlink communication.
